(19) United States
(12) Patent Application Publication
(10) Pub. No.: US 2003/0106582 A1
(43) Pub. Date: Jun. 12, 2003

(54) Method and system for automatically controlling water level in storage tank through wireless control process

(76) Inventor: Hyun-Oh Jeong, Hampyung-kun (KR)

Correspondence Address: Abelman Frayne & Schwab, 150 East 42nd Street, New York, NY, 10017-5612, US

(21) Appl. No.: 10/204,284

(22) PCT Filed: Feb. 16, 2001
(86) PCT No.: PCT/KR01/00235

(30) Foreign Application Priority Data
Feb. 19, 2000 (KR) 2000/8068

(51) Int. Cl. F17D 1/00

(52) U.S. Cl. 137/2; 137/11; 137/12

(57) ABSTRACT

The object of this invention is to provide a method and system for automatically controlling water level in a storage tank through a wireless control process. This system includes an intake chamber (24), an intake pumping means (22) set within the chamber (24), a water feed pipe (36) extending from the pumping means (22) to a water storage tank (300), a pressure sensing means (34) for sensing water pressure within the pipe (36), a check valve (33) for preventing backflow of water within the pipe (36), and a drive controller (110) for processing data from the pressure sensing means (34) and outputting a signal to a main controller (100). This method and system senses water pressure within the water feed pipe using the water pressure sensing means to automatically and effectively control the water level within the water storage tank through a wireless control process, particularly in the case of an excessively long water feed pipe.

### TECHNICAL FIELD

The present invention relates in general to methods and systems for automatically controlling a water level wirelessly, and more particularly to a method and system for automatically controlling a water level within a water storage tank wirelessly, which can sense water pressure within a water feed pipe through a water pressure sensor mounted on the pipe and automatically determine and control the amount of underground water, top water, seepage water, soil water, waste water or etc. (referred to hereinafter as raw water) to be stored in the water storage tank on the basis of the sensed water pressure, thereby efficiently controlling the water level in the water storage tank, particularly in the case where a feeding distance of the raw water from a water source to the storage tank through the water feed pipe is considerably long (for example, several ten m to several Km).

### BACKGROUND ART

As well known to those skilled in the art, water level control apparatus are installed in certain regions to store raw water in water storage tanks. Such a conventional water level control apparatus comprises a pumping unit for pumping out raw water from a water sump, reservoir or underground water source, a water feed pipe for feeding the raw water pumped out by the pumping unit to a water storage tank installed apart from the pumping unit at a certain distance, a water level sensor for sensing the amount or level of raw water within the water storage tank, and a controller for receiving a sense signal from the water level sensor via an electric cable, analyzing the received sense signal and controlling the operation of the pumping unit as a result of the analysis.

In the above-mentioned conventional water level control apparatus, however, the pipe for feeding of the raw water and the electric cable for transfer of the sense signal must be together buried under the ground, or the electric cable must be connected in an aerial manner separately from the buried pipe, resulting in the necessitation of dual connection work. Further, the aerial or buried electric cable is liable to leak, or be broken or short-circuited due to external conditions, so that the controller may fail to normally transmit a control signal to the pumping unit. In this case, the raw water stored in the water storage tank may overflow beyond the tank. Moreover, in the case where the pumping unit is continuously driven, it may be reduced in durability and in turn in lifetime. Further, the breaking, short-circuit or leakage of the electric cable may cause an electric shock to personnel as well as a power loss. Furthermore, the arrangement of the electric cable separate from the water feed pipe may lead to an increase in installation and maintenance costs of the water level control apparatus.

In order to overcome the above problems, there have been proposed automatic wireless water level control apparatus capable of removing a conventional electric cable, mounting a water pressure sensor on a water feed pipe to sense water pressure within the pipe, wirelessly receiving a sense signal from the water pressure sensor and automatically controlling the amount or level of raw water within a water storage tank in response to the received sense signal, thereby solving all problems with the electric cable and controlling the water level within the storage tank more accurately.

The construction of one such conventional automatic wireless water level control apparatus is shown in FIG. 1 herein. As shown in this drawing, the conventional automatic wireless water level control apparatus comprises an intake chamber 2 excavated to a predetermined depth under the ground for taking in raw water, an intake pumping unit 3 set within the intake chamber 2 for pumping out the raw water from the chamber 2, a water feed pipe 5 of a certain diameter connected to the intake pumping unit 3, at least one electrode rod 4 of a certain length installed within the intake chamber 2, a water pressure sensor 6 provided in the water feed pipe 5 for sensing pressure of the raw water fed from the pumping unit 3 through the pipe 5, a water storage tank 9 connected to the end of the water feed pipe 5 at a certain portion thereof for storing the raw water fed from the pumping unit 3 through the pipe 5 to a predetermined amount, and a controller 1 for controlling the operation of the pumping unit 3 in response to a sense signal from the water pressure sensor 6. The controller 1 is adapted to analyze the sense signal from the water pressure sensor 6 and turn on or off the supply of power to the pumping unit 3 over a power supply line 7 in accordance with the analyzed result.

The electrode rod 4, which is one or more in number, functions to sense the amount or level of the raw water contained within the intake chamber 2 and transfer the sensed result to the controller 1 over a signal line 8. To this end, the electrode rod 4 has a resistance varying with the level of the raw water within the intake chamber 2 and provides its output current value based on the varying resistance to the controller 1. As a result, the controller 1 can recognize the water level within the intake chamber 2 from the output current value from the electrode rod 4. The intake pumping unit 3 is driven by power supplied from the controller 1 via the power supply line 7 to pump the raw water from the intake chamber 2 into the water feed pipe 5. As the amount of the raw water within the intake chamber 2 reduces gradually, the water level within the chamber 2 becomes lower, thereby causing the pumping unit 3 to perform a no-load operation while pumping out no water from the chamber 2. In this regard, upon judging the no-load operation of the pumping unit 3 from the sense signal from the electrode rod 4, the controller 1 interrupts the supply of power to the pumping unit 3 so as to prevent it from being damaged.

On the other hand, raw water will fill the intake chamber 2 after the operation of the intake pumping unit 3 is stopped. At this time, the electrode rod 4 senses the level of the raw water within the chamber 2, and the controller 1 determines from a sense signal from the rod 4 whether the water level within the chamber 2 is above a predetermined value. If the water level within the chamber 2 is determined to be above the predetermined value, then the controller 1 supplies power to the pumping unit 3 to resume the operation thereof to pump out the raw water from the chamber 2.

In the conventional automatic wireless water level control apparatus, as described above, the controller analyzes the water level within the intake chamber on the basis of the sense signal from the electrode rod and controls the intake pumping unit as a result of the analysis. Further, the controller analyzes the water level (or amount) within the water storage tank on the basis of the sense signal from the water pressure sensor within the water feed pipe and controls the intake pumping unit as a result of the analysis. However, the pumping unit and electrode rod are installed within the intake chamber under the condition that they are buried to predetermined depths under the ground. For this reason, the controller may fail to accurately sense the water level within the intake chamber due to damage to the electrode rod or the breaking or short-circuit of the buried signal line. In this case, the controller cannot accurately control the pumping unit, which may lead to a deterioration or damage in the pumping unit and in turn the replacement of the unit and rod. But, this replacement costs a great deal, as well as being not easy.

Provided that the controller does not accurately sense the amount of raw water within the intake chamber through the electrode rod as stated above, it will not be able to accurately control the pumping unit, resulting in an inconvenience of use.

Furthermore, the controller controls the pumping unit by driving a counter or electronic switch in response to only a simple electrical signal input. In this connection, the controller cannot perform a variety of control functions and thus a more precise control operation.

### DISCLOSURE OF THE INVENTION

Therefore, the present invention has been made in view of the above problems, and it is an object of the present invention to provide an automatic wireless water level control system wherein, instead of installing an electrode rod within an intake chamber to sense the amount or level of raw water within the chamber, a water pressure sensor is mounted on a water feed pipe to sense pressure of raw water pumped out from the intake chamber by an intake pumping unit, the water amount or level within the intake chamber is judged from the water pressure sensed by the water pressure sensor, and the pumping unit is controlled in operation in accordance with the judged result.

It is another object of the present invention to provide an automatic wireless water level control system wherein at least one water pressure sensor is provided in a water feed pipe or formed integrally with the pipe therein to sense pressure of raw water fed through the pipe, a determination is made on the basis of the water pressure sensed by the water pressure sensor as to whether the level of raw water within an intake chamber is lower than a predetermined value when an intake pumping unit pumps out the chamber for a predetermined period of time under the condition that the water amount within the intake camber is limited, and the pumping unit is controlled in drive speed according to time or pressure on the basis of the determined result.

It is a further object of the present invention to provide an automatic wireless water level control system wherein separate control means is provided in a controller to perform a variety of improved control functions, a display window is provided to visually display information regarding the operation of the system so as to facilitate settings for water level or amount display, set state display, operated state display, timer display, etc., and an intake pumping unit is readily controlled in such a manner that it is turned off if pressure of raw water stored within a water storage tank becomes higher than a first predetermined value after the pumping unit is driven, and resumed in operation if the water pressure within the water storage tank becomes lower than a second predetermined value due to water use after the pumping unit is turned off, so that a constant amount of raw water can always be stored in the storage tank.

It is a further object of the present invention to provide an automatic wireless water level control system wherein a controller judges a variation in water pressure sensed by a water pressure sensor with a variation in water level within an intake chamber while an intake pumping unit pumps out the intake chamber under the condition that the water amount within the chamber is unrestricted, measures a variation in amount of current supplied to the pumping unit and controls the operation of the pumping unit in accordance with the judged result and measured result so as to prevent the pumping unit from being deteriorated and damaged due to its continuous operation.

It is another object of the present invention to provide a method for automatically controlling a water level within a water storage tank wirelessly, which is capable of more accurately setting high and low levels of raw water to be stored within the water storage tank and more effectively re-setting the high and low water levels by more accurately setting a fluctuation or fine pressure variation of raw water of the high level and minimizing a fluctuation or fine pressure variation of raw water of the low level.

It is yet another object of the present invention to provide a method for automatically controlling a water level within a water storage tank wirelessly, which is capable of sensing a raw water pumping state, pumping stop state, pumping resumption state, etc. on the basis of a variety of variations in pressure of raw water fed from an intake chamber through a water feed pipe and re-setting the sensed states through comparison with initial values, thereby conveniently administrating and maintaining raw water pumped out from the intake chamber and controlling the raw water level more intelligently.

In accordance with the present invention, the above and other objects can be accomplished by the provision of a method for automatically controlling a water level wirelessly, comprising the steps of a) installing an automatic wireless water level control system and setting a variety of initial values about water pressure within a water storage tank; b) driving intake pumping means to intake raw water from an intake chamber; c) sensing variations in water pressure within a water feed pipe through water pressure sensing means while raw water pumped out by the pumping means is fed to the water storage tank through the water feed pipe, and then determining whether the sensed water pressure variations satisfy a first condition; d) re-setting an average water pressure value of the water pressure variations sensed at the above step c) as an initial water pressure value if the water pressure variations sensed at the above step c) satisfy the first condition; e) sensing variations in water pressure within the water feed pipe through the water pressure sensing means after the initial water pressure value is re-set and then determining whether the sensed water pressure variations satisfy a second condition; f) re-setting an average water pressure value of the water pressure variations sensed at the above step e) as a high water level pressure value if the water pressure variations sensed at the above step e) satisfy the second condition, sensing variations in water pressure within the water feed pipe through the water pressure sensing means and determining whether the sensed water pressure variations satisfy a third condition; g) stopping the operation of the pumping means if the water pressure variations sensed at the above step f) satisfy the third condition; h) sensing variations in water pressure within the water feed pipe through the water pressure sensing means after the operation of the pumping means is stopped, determining whether the sensed water pressure variations satisfy a fourth condition and then re-setting an average water pressure value of the sensed water pressure variations as a low water level pressure value if the sensed water pressure variations satisfy the fourth condition; i) sensing water pressure within the water feed pipe through the water pressure sensing means for a certain period of time that raw water stored in the water storage tank is consumed after the low water level pressure value is re-set and then determining whether the sensed water pressure value is the re-set low water level pressure value; and j) sensing variations in water pressure within the water feed pipe through the water pressure sensing means if the water pressure value sensed at the above step i) is the re-set low water level pressure value, determining whether the sensed water pressure variations satisfy a fifth condition and then resuming the operation of the pumping means to re-intake raw water from the intake chamber, if the sensed water pressure variations satisfy the fifth condition.

In accordance with another aspect of the present invention, there is provided a system for automatically controlling a water level wirelessly, comprising an intake chamber for intaking raw water; intake pumping means for pumping out the raw water from the intake chamber; a water feed pipe for feeding the raw water pumped out by the pumping means; water pressure sensing means for sensing water pressure within the water feed pipe; a check valve for preventing a backflow of the raw water pumped out by the intake pumping means; a water storage tank for storing the raw water fed through the water feed pipe; a drive controller for processing electrical data from the water pressure sensing means; and a main controller for monitoring, controlling and displaying a variety of states of the system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a conventional apparatus for automatically controlling the level of raw water intaken and fed to a remote water storage tank;

FIG. 2 is a block diagram showing the construction of an automatic wireless water level control system in accordance with the present invention;

FIG. 3 is a view showing a configuration of a control panel of the automatic wireless water level control system in accordance with the present invention;

FIG. 4 is a view showing a first embodiment of the automatic wireless water level control system in accordance with the present invention;

FIG. 5 is a graph showing variations in water pressure sensed by a water pressure sensor in FIG. 4;

FIG. 6 is a view showing a second embodiment of the automatic wireless water level control system in accordance with the present invention;

FIG. 7 is a graph showing variations in water pressure sensed by a water pressure sensor in FIG. 6;

FIG. 8 is a view showing a third embodiment of the automatic wireless water level control system in accordance with the present invention;

FIGS. 9a and 9b are graphs showing variations in water pressures sensed by water pressure sensors in FIG. 8;

FIG. 10 is a view showing a fourth embodiment of the automatic wireless water level control system in accordance with the present invention;

FIGS. 11a and 11b are graphs showing variations in water pressures sensed by water pressure sensors in FIG. 10;

FIG. 12 is a view showing a fifth embodiment of the automatic wireless water level control system in accordance with the present invention;

FIGS. 13a to 13c are graphs showing variations in water pressures sensed by water pressure sensors in FIG. 12;

FIG. 14 is a view showing a first embodiment of a structure for sensing water pressure within a water storage tank in accordance with the present invention;

FIG. 15 is a view showing a second embodiment of the structure for sensing the water pressure within the water storage tank in accordance with the present invention;

FIG. 16 is a view showing a third embodiment of the structure for sensing the water pressure within the water storage tank in accordance with the present invention;

FIG. 17 is a view showing a structure of a float connected to the end of a water feed pipe via a T-shaped pipe coupling and discharge pipe in accordance with the present invention;

FIG. 18 is a view showing a structure of an auxiliary pipe for sensing the water pressure within the water storage tank in accordance with the present invention;

FIG. 19 is a flowchart illustrating the operation of the automatic wireless water level control system in accordance with the present invention when an automatic mode is set on the control panel;

FIG. 20 is a flowchart illustrating the operation of the automatic wireless water level control system in accordance with the present invention when the automatic mode is set on the control panel and a limited amount of raw water is fed to the water storage tank;

FIG. 21 is a flowchart illustrating the operation of the automatic wireless water level control system in accordance with the present invention when a manual mode is set on the control panel;

FIG. 22 is a flowchart illustrating the operation of a main controller in accordance with the present invention;

FIG. 23 is a sectional view illustrating the installation of a water pressure sensor within the water feed pipe in accordance with the present invention;

FIG. 24 is a partially enlarged, sectional view of FIG. 23;

FIGS. 25a to 25d are sectional views showing different structures of the water feed pipe in accordance with the present invention;

FIG. 26 is a schematic view showing connections of a plurality of pumping units and a plurality of water feed pipes to one water storage tank in accordance with the present invention;

FIG. 27 is a schematic view showing connections of one pumping unit and a plurality of water feed pipes to a plurality of water storage tanks in accordance with the present invention;

FIG. 28 is a flowchart illustrating the overall operation of the automatic wireless water level control system in accordance with the present invention;

FIG. 29 is a view showing a sixth embodiment of the automatic wireless water level control system in accordance with the present invention;

FIGS. 30 to 32 are views showing yet other embodiments of the structure for sensing the water pressure within the water storage tank in accordance with the present invention;

FIG. 33 is a sectional view showing a structure of a float connected to the end of the water feed pipe in accordance with the present invention;

FIG. 34 is a sectional view showing a structure of a reflector connected to the end of the water feed pipe in accordance with the present invention;

FIG. 35 is a graph showing the entire water pressure variations in the automatic wireless water level control system in accordance with the present invention;

FIG. 36 is a flowchart illustrating an automatic wireless water level control method in accordance with the present invention;

FIG. 37 is a graph illustrating a low water level sensing and re-pumping operation in accordance with the present invention;

FIG. 38 is a view showing a seventh embodiment of the automatic wireless water level control system in accordance with the present invention, which is applied to a pressurized water tank; and

FIG. 39 is a graph showing water pressure variations in the automatic wireless water level control system applied to the pressurized water tank in accordance with the present invention.

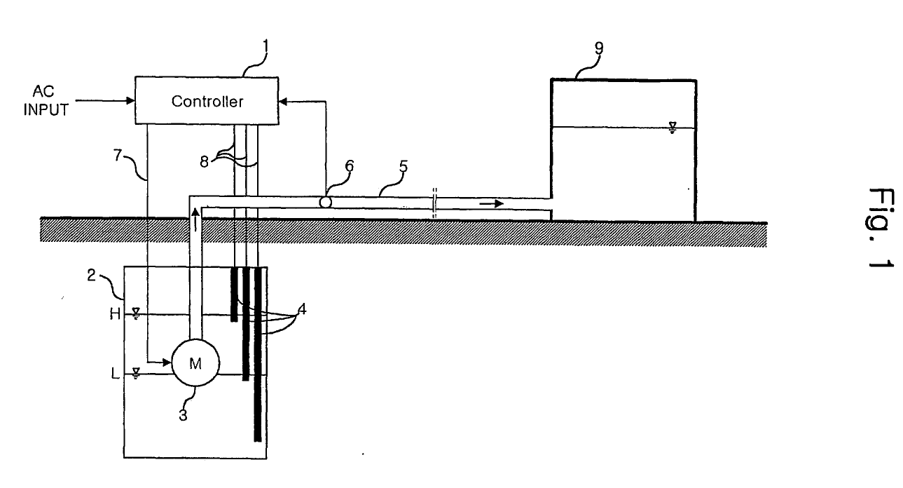

### BEST MODE FOR CARRYING OUT THE INVENTION

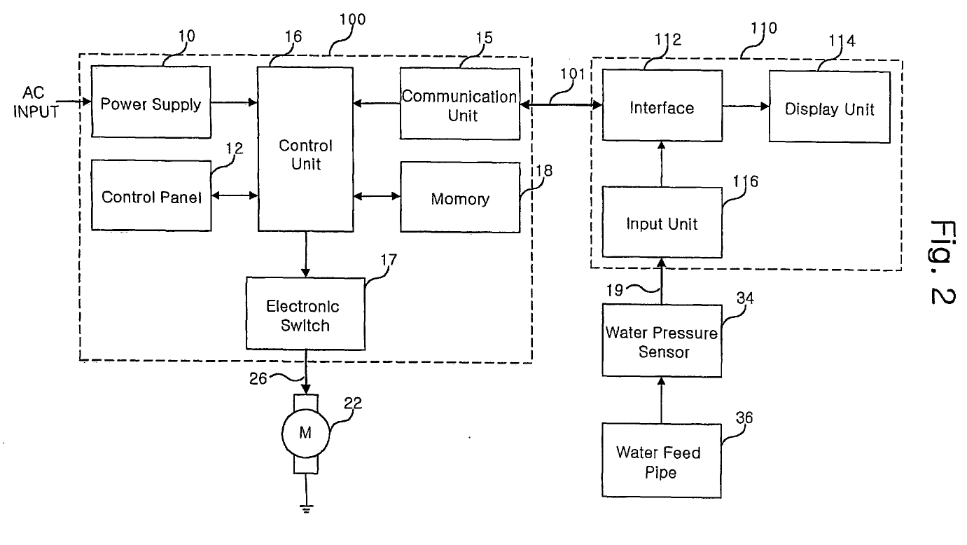

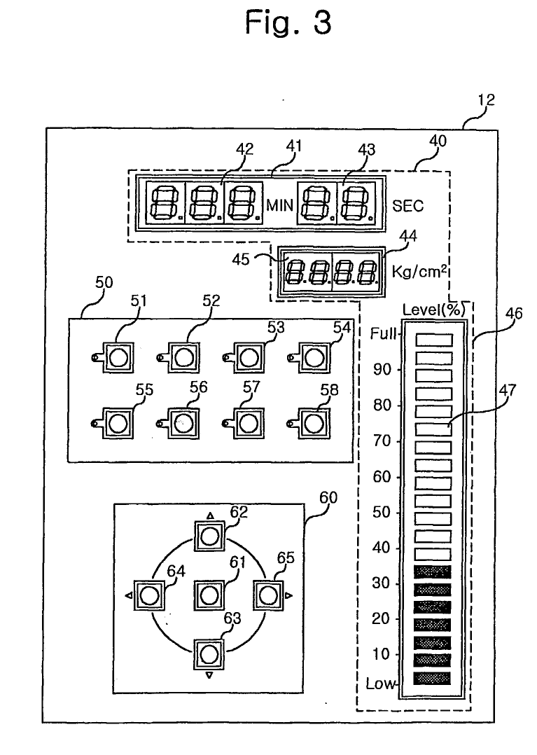

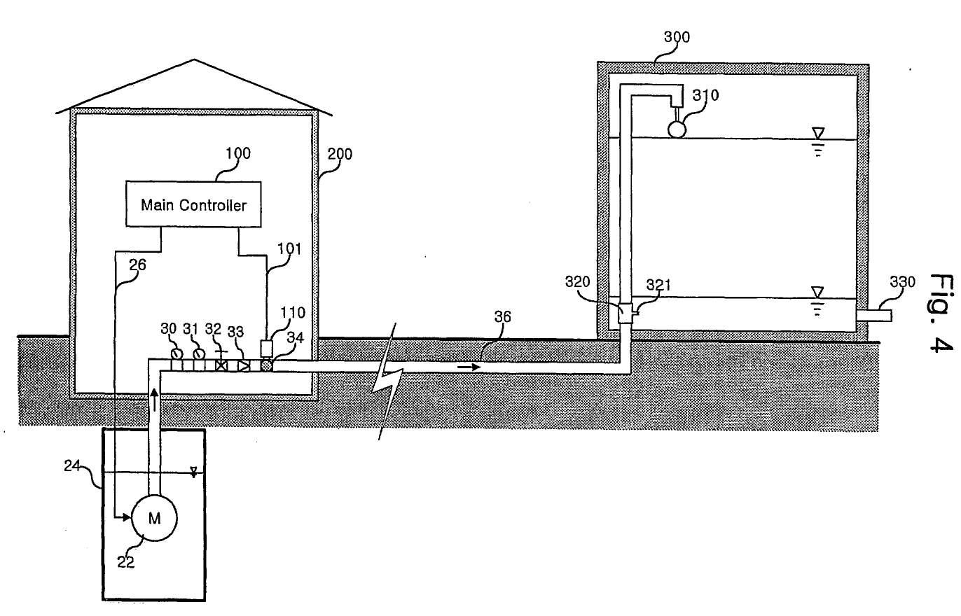

FIG. 2 is a block diagram showing the construction of an automatic wireless water level control system in accordance with the present invention, FIG. 3 is a view showing a configuration of a control panel of the automatic wireless water level control system in accordance with the present invention and FIG. 4 is a view showing a first embodiment of the automatic wireless water level control system in accordance with the present invention.

The automatic wireless water level control system of the present invention comprises an intake chamber 24 excavated to a predetermined depth under the ground for taking in raw water such as underground water, top water, seepage water, soil water, waste water or etc. The intake chamber 24 is able to take in the raw water limitedly or unlimitedly according to a water storage or feed state. An intake control station 200 is adapted to control the intake chamber 24. To this end, the intake control station 200 includes the intake chamber 24, a water feed pipe 36 extending from the chamber 24, various sensors, various controllers, and a main controller 100 for controlling an intake pumping unit 22.

The intake pumping unit 22 is set within the intake chamber 24 to a predetermined depth. The pumping unit 22 is driven by a drive voltage from a power supply 10 to pump out raw water from the intake chamber 24. This pumping unit 22 is preferably installed under water to pump out raw water under the ground or in a water source (for example, a reservoir, river, sea or the like). Alternatively, the pumping unit 22 may be installed within an intake chamber on the ground in consideration of physiographic or positional factors. A motor pump is preferably used as the pumping unit 22. However, it should be noted that any means is applicable to the pumping unit 22 as long as it is capable of pumping out raw water.

The water feed pipe 36 extends from the intake pumping unit 22 within the intake chamber 24 to a water storage place to feed or discharge raw water pumped out by the pumping unit 22. The pipe 36 is preferably buried under the ground although it can be installed aerially or on the ground.

A water pressure sensor 34 is mounted on the water feed pipe 36 to simultaneously sense pressure of the raw water pumped out by the intake pumping unit 22, and pressure that raw water stored in a water storage tank 300 applies through the pipe 36 by atmospheric pressure. This pressure sensor 34 is preferably provided in the water feed pipe 36 extending from the pumping unit 22, at an aerial position of the pipe 36 or a position capable of sensing a pumping state of the pumping unit 22 the most readily. The pressure sensor 34 is generally one in number although one or more may be applied as needed.

A check valve 33 is provided in the water feed pipe 36 to prevent a backflow of the raw water pumped out by the intake pumping unit 22 by setting the direction of flow of the raw water through the pipe 36. The check valve 33 has a micro-hole for preventing a damage to the water feed pipe 36 and an error in the water pressure sensor 34 resulting from overpressure generated in the pipe 36 at the moment that no water is fed from the intake pumping unit 22.

The water storage tank 300 is connected to the end of the water feed pipe 36 at a certain portion thereof for storing the raw water fed from the intake pumping unit 22 through the pipe 36. This storage tank 300 has a certain volume capable of storing the raw water, as in general storage tanks. A separate water feed pipe 330 extends from the water storage tank 300 to discharge or feed the raw water stored in the storage tank 300 to another storage means.

A T-shaped pipe coupling 320 is provided at a lower portion inside the water storage tank 300. The T-shaped pipe coupling 320 has an inlet port connected to the end of the water feed pipe 36 extending from under the ground to the storage tank 300, and an outlet port connected to a float 310 via a discharge pipe. A water pressure sensing pipe 321 extends from an intermediate point between the inlet and outlet ports of the coupling 320 to sense pressure of the raw water stored in the storage tank 300. The float 310 functions to turn on/off the discharge of the raw water from the water feed pipe 36 to the water storage tank 300 via the discharge pipe. The water pressure sensing pipe 321 preferably has a smaller diameter than the water feed pipe 36, for example, on the order of 1:10.

A drive controller 110 is provided to process electrical data from the water pressure sensor 34. For the purpose of minimizing a loss in a signal line 19 leading from the water pressure sensor 34, the drive controller 110 is adapted to convert electrical data from the pressure sensor 34 into digital data and transmit the converted digital data to the main controller 100.

The main controller 100 is adapted to monitor, control and display a variety of states of the system. Main components in the main controller 100 and drive controller 110 are shown in the system block diagram of FIG. 2.

The main controller 100 includes a power supply 10 for outputting an external input alternating current (AC) voltage (AC 220V) directly or converting it into a direct current (DC) voltage and outputting the converted DC voltage. The power supply 10 removes a surge or noise component from the input AC voltage and connects the resulting AC voltage directly to the intake pumping unit 22. Also, the power supply 10 drops, rectifies and smoothes the input AC voltage and outputs the resulting DC voltage of a predetermined level to an electronic circuitry of the main controller 100 to drive it.

A control panel 12 is mounted on the front surface of the main controller 100 to set an operation mode of the intake pumping unit 22 and display an operated state of the pumping unit 22. Electric and electronic circuits are arranged inside the control panel 12 to control the system operation. By virtue of the control panel 12, a user can set a mode for the operation of the intake pumping unit 22, control the operation of the pumping unit 22 in the set mode and recognize the controlled state with the naked eye.

A control unit 16 is provided in the main controller 100 to analyze an output signal from the control panel 12 and output a control signal back to the panel 12 or a drive control signal to the intake pumping unit 22 in accordance with the analyzed result. The control unit 16 preferably includes a microprocessor containing a control program.

A memory 18 is provided in the main controller 100 to output set data or store input data. Namely, the memory 18 is adapted to output a set program or data or store external input information data under the control of the control unit 16. The memory 18 preferably includes a read only memory (ROM) (an erasable programmable read only memory (EPROM) or electrically erasable and programmable read only memory (EEPROM)) capable of storing or erasing data, or a random access memory (RAM) for temporarily storing data.

An electronic switch (for example, a relay) 17 is provided in the main controller 100 to supply or interrupt power from the power supply 10 to the intake pumping unit 22. The electronic switch 17 is connected to the pumping unit 22 via a power supply line 26 under the control of the control unit 16. This switch 17 preferably includes fixed contacts A and B and a common contact to control the pumping unit 22.

A communication unit 15 is provided in the main controller 100 to transmit and receive water pressure and control signals. The communication unit 15 communicates with the drive controller 110 via an RS-232C 101 to receive a signal about the current water pressure sensed by the water pressure sensor 34, from the drive controller 110, and transfer the received water pressure signal to the control unit 16 for monitoring and control of the intake pumping unit 22.

The drive controller 110 includes an input unit 116 for inputting an analog (voltage or current) water pressure signal from the water pressure sensor 34, an interface 112 for converting the analog water pressure signal inputted by the input unit 116 into a digital signal and transferring the converted digital signal to the main controller 100 via the RS-232C 101, and a display unit 114 for providing a visual indication of an operated state of the drive controller 110.

The control panel 12 includes, as shown in FIG. 3, a display window 40 for visually displaying information regarding the operation and settings of the system. The display window 40 is composed of state display means 41 for displaying the current state of the main controller 100, water pressure display means 44 for displaying water pressure within the water feed pipe 36, and water level display means 46 for displaying the level of raw water within the water storage tank 300.

The state display means 41 in the display window 40 is a basic display module for displaying information ‘run’ indicative of a state where the intake pumping unit 22 is in operation in an automatic mode, information ‘USE’ indicative of a state where the operation of the pumping unit 22 is stopped in the automatic mode because the water level within the water storage tank 300 is high, and information ‘OFF’ indicative of a state where the pumping unit 22 can be manually turned on/off in the current state.

These display means 41, 44 and 46 in the display window 40 are provided to enable the user to readily recognize the current control state of the system. That is, the display means 41, 44 and 46 are adapted to display the automatic or manual mode of the pumping unit 22, the current mode of the system, an error in operation of the system, an operation start or stop time and a running period of time being set and counted on a second or minute basis. To this end, the state display means 41 includes a plurality of displays 42 and 43, the water pressure display means 44 includes a display 45, and the water level display means 46 includes a display 47. The displays 42, 43, 45 and 47 may preferably be LED-arrays, 7-segment arrays or TFT-LCDs.

The displays 42 and 43 in the state display means 41 are adapted to display a variety of information including a time interval being counted, for example, up to 000 min 00 sec. The display 45 in the pressure display means 44 is adapted to display water pressure, for example, up to 0000 Kg/cm².

The display 47 in the water level display means 46 is adapted to provide a visual indication of the level of raw water within the intake chamber 24 or water storage tank 300. To this end, the display 47 includes a plurality of display bars turned on/off for displaying the water level as a percentage (%) of a full level. For example, upon recognizing that the current water level is high, the main controller 100 turns off the intake pumping unit 22. Thereafter, at the time that the information ‘USE’ is displayed on the state display means 41 after a pressure stabilization period of time elapses, the main controller 100 calculates the current water level on the basis of the current water pressure value and a low water level value set by a level setting key 53 in a function key input unit 50 and displays the calculated water level value on the display 47 as a percentage (%).

The water level display means 46 can display the level of raw water within the intake chamber 24 in response to a user's request. That is, the water level display means 46 can be configured to display both or either of the water levels within the water storage tank 300 and intake chamber 24.

The function key input unit 50 is provided on the control panel 12 to set state values for a normal operation of the main controller 100 according to user's selections. The control panel 12 further includes a selection key input unit 60 for inputting key signals selected by the user after the main controller 100 is set to the state values.

The function key input unit 50 includes a mode setting key 51 for setting the operation mode of the intake pumping unit 22 to the automatic mode or manual mode, and a motor setting key 52 for driving the pumping unit 22 when the operation mode of the pumping unit 22 is set to the manual mode. The level setting key 53 is provided in the function key input unit 50 to set a water level depending on water pressure sensed by the water pressure sensor 34. The function key input unit 50 further includes a restart time setting key 54 for setting an operation restart time of the intake pumping unit 22 when the current water pressure becomes abnormal as the pumping unit 22 is driven, a start time setting key 55 for setting a stabilization period of time based on water pressure sensed by the water pressure sensor 34 when the pumping unit 22 is driven because the current water level is low, an end time setting key 56 for setting a period of time that the pumping unit 22 is driven before it is turned off after the current water level is determined to be full from water pressure sensed by the water pressure sensor 34, a password setting key 57 for maintaining the security of the main controller 100, and a cancel key 58 for canceling a corrected value after the main controller 100 is set to the state values.

In the function key input unit 50, the mode setting key 51 is adapted to set the operation mode of the intake pumping unit 22 to the automatic mode or manual mode. In the automatic mode, the pumping unit 22 is automatically driven on the basis of set and stored data. In the manual mode, the pumping unit 22 is compulsorily turned on or off irrespective of the set and stored data.

The motor setting key 52 is used only in the manual mode to compulsorily turn on or off the contacts of the electronic switch 17. This key 52 includes a red lamp turned on/off regardless of the automatic and manual modes. The red lamp is turned on if the pumping unit 22 is turned on, and off if the pumping unit 22 is turned off.

The level setting key 53 is adapted to set a height from a high water level that the main controller 100 recognizes to turn off the pumping unit 22, to a low water level that the main controller 100 recognizes to turn on the pumping unit 22. The state display means 41 displays a value set by the level setting key 53 as a number of five figures, the first three figures being a meter unit (m) and the following two figures being a centimeter unit (cm). The level setting key 53 preferably sets a value within the range of, for example, 10 cm to 250 m.

The restart time setting key 54 is adapted to set an operation restart time of the intake pumping unit 22 when the current water pressure becomes abnormal as the pumping unit 22 is driven. The main controller 100 analyzes the current water pressure after turning on the pumping unit 22. Upon determining from the analyzed result that the current pressure is abnormal due to a swirling, etc., the main controller 100 turns off the pumping unit 22. Then, the main controller 100 resumes the operation of the pumping unit 22 at the moment that the set operation restart time period has elapsed. The restart time setting key 54 preferably sets the operation restart time period within the range of 000 min 00 sec to 999 min 99 sec.

The start time setting key 55 is adapted to set a stabilization period of time based on water pressure sensed by the water pressure sensor 34 when the pumping unit 22 is driven because the current water level is low. Namely, the start time setting key 55 sets a stabilization period of time based on water pressure sensed by the water pressure sensor 34 when the pumping unit 22 is turned on as the current water level becomes low. The pressure stabilization time period is preferably set within the range of 00 sec to 99 sec.

The end time setting key 56 is adapted to set a period of time that the pumping unit 22 is driven before it is turned off after the current water level is determined to be high from water pressure sensed by the water pressure sensor 34. This time period is preferably set within the range of 00 sec to 99 sec.

The password setting key 57 is used to maintain the security of the main controller 100 according to a user's selection. For example, for initial password registration, if the user pushes the password setting key 57 once under the condition that a ‘password’ lamp in the function key input unit 50 remains off, password entry request information is displayed on the state display means 41. Then, the user enters a password using the selection key input unit 60 and pushes a storage setting key 61 in the selection key input unit 60 once. As a result, the entered password is registered and stored. An initially stored value is ‘00000’.

The password lamp in the function key input unit 50 remains on under the condition that a password is registered. For use of any one of the mode setting key 51, motor setting key 52, level setting key 53, restart time setting key 54, start time setting key 55, end time setting key 56 and password setting key 57 in the function key input unit 50, the password entry request information is displayed on the state display means 41. Then, the user enters the registered password using the selection key input unit 60 and pushes the storage setting key 61 in the selection key input unit 60 once. Provided that the entered password is not the same as the registered password, the user cannot use any key of the function key input unit 50.

The cancel key 58 is used to cancel a corrected value after the main controller 100 is set to the state values. If the cancel key 58 is pushed, a value, not stored, is canceled and a current state value is maintained.

The function key input unit 50 further includes a state indication lamp turned on or off or flickered for indicating a state in operation or operated.

On the other hand, the selection key input unit 60 is provided in the control panel 12 to input key signals selected by the user after the main controller 100 is set to the state values. The storage setting key 61 is provided in the selection key input unit 60 to store values set by the user. The selection key input unit 60 further includes an up setting key 62 for increasing a number displayed on the state display means 41 after the main controller 100 is set, a down setting key 63 for reducing a number displayed on the state display means 41 after the main controller 100 is set, a figure setting key 64 for shifting to the left figures of a number displayed on the state display means 41 after the main controller 100 is set, and a figure setting key 65 for shifting to the right figures of a number displayed on the state display means 41 after the main controller 100 is set.

A switching mode power supply (SMPS) is used to supply power to the main controller 100 and intake pumping unit 22. An AC voltage is used as the input to the SMPS. This AC voltage is preferably a free voltage of AC 90˜260V.

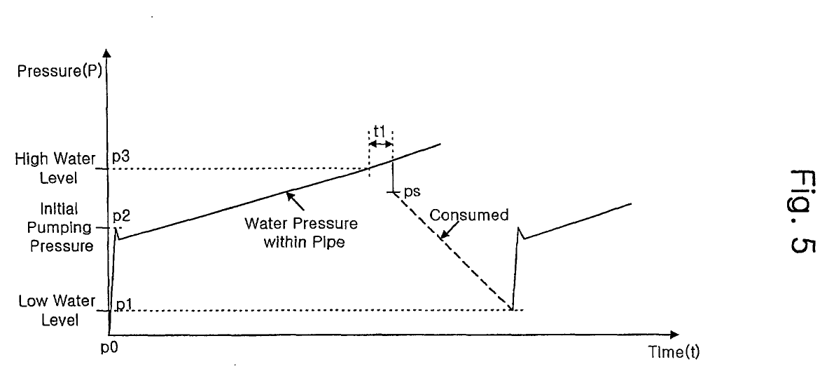

In the first embodiment of FIG. 4, one water pressure sensor 34 is provided in the water feed pipe 36, and an unlimited amount of raw water is intaken from the intake chamber 24. FIG. 5 is a graph showing variations in water pressure sensed by the water pressure sensor 34.

Assume that an unrestricted amount (virtually an unlimited amount) of raw water is intaken from the intake chamber 24, namely, raw water intaken from the intake chamber 24 is continuously fed to the water storage tank 300, under the condition that the water pressure sensor 34 is mounted on the water feed pipe 36. If the intake pumping unit 22 pumps raw water from the intake chamber 24 to the water storage tank 300, the water pressure sensor 34 senses water pressure generated within the water feed pipe 36, converts the sensed water pressure into an electrical signal and outputs the converted electrical signal to the control unit 16. If the water pressure sensed by the pressure sensor 34 increases and then exceeds a predetermined value p3 for a predetermined period of time t1, the control unit 16 outputs a first control signal to the electronic switch 17 to interrupt power to the pumping unit 22. In the case where the water pressure sensed by the pressure sensor 34 falls below a predetermined value p1, the control unit 16 outputs a second control signal to the electronic switch 17 to supply power to the pumping unit 22.

As seen from the graph of FIG. 5, in the initial condition where the intake chamber 24, main controller 100, water feed pipe 36 and water storage tank 300 are installed, the water pressure sensed by the water pressure sensor 34 begins with an initial value p0 when raw water is intaken from the intake chamber 24. Thereafter, the pumping unit 22 is automatically driven at the moment that the sensed water pressure reaches the value p1 (indicative of a low water level) after raw water is intaken from the intake chamber 24. The pumping unit 22 performs an initial pumping operation at pressure p2, and the water feed pipe 36 preferably has a sufficient strength to withstand the initial pumping pressure p2. Water pressure within the pipe 36 will increase gradually and reach the value p3 (indicative of a high water level). If water pressure higher than or equal to the value p3 is maintained for the predetermined time period t1, the control unit 16 in the main controller 100 controls the electronic switch 17 to interrupt power to the pumping unit 22. As a result, because of no water pumped out by the pumping unit 22, the water pressure sensor 34 senses only water pressure within the storage tank 300. At this time, the sensed water pressure will have a value ps lower than the high water level pressure value p3. Thereafter, at the moment that the sensed water pressure reaches the low water level pressure value p1 as raw water stored within the storage tank 300 is consumed, the control unit 16 controls the electronic switch 17 to supply power to the pumping unit 22, thereby causing the water pressure sensor 34 to sense water pressure within the water feed pipe 36.

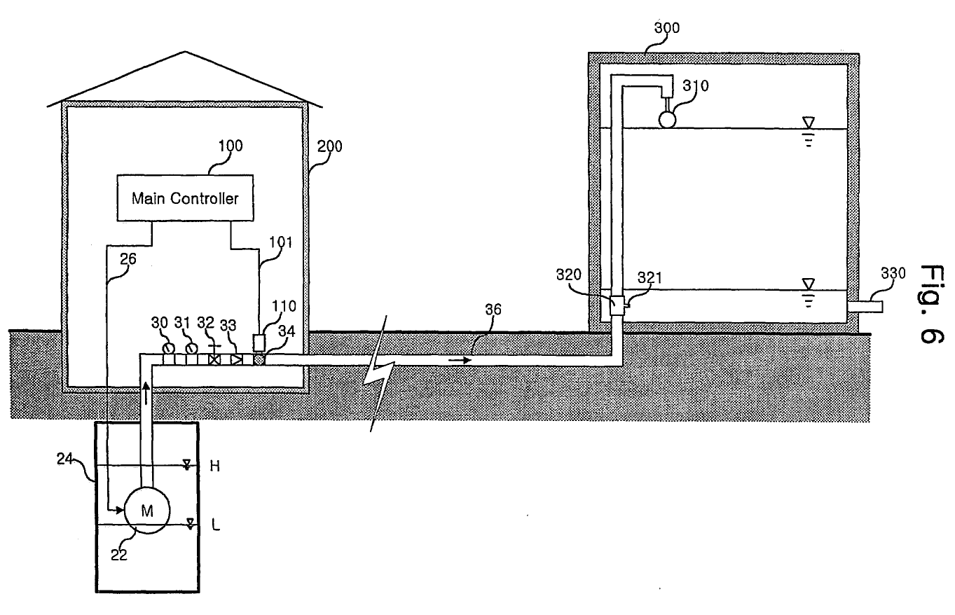

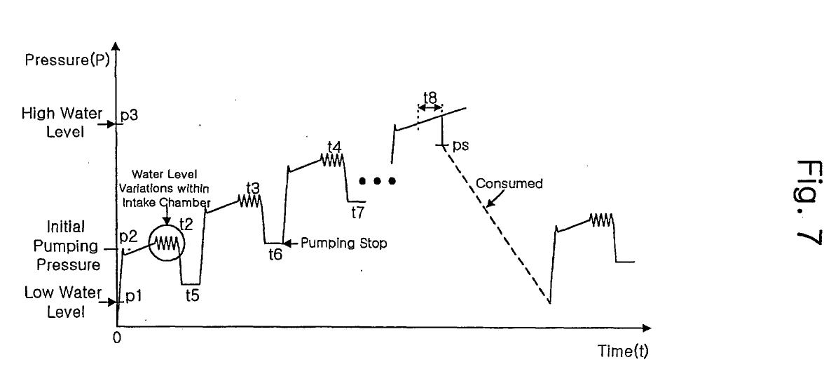

FIG. 6 is a view showing a second embodiment of the automatic wireless water level control system in accordance with the present invention. In the second embodiment of FIG. 6, one water pressure sensor 34 is provided in the water feed pipe 36, and a limited amount of raw water is intaken from the intake chamber 24. FIG. 7 is a graph showing variations in water pressure sensed by the water pressure sensor 34.

Assume that a limited amount of raw water is intaken from the intake chamber 24 under the condition that the water pressure sensor 34 is mounted on the water feed pipe 36. If the intake pumping unit 22 pumps raw water from the intake chamber 24 to the water storage tank 300, the water pressure sensor 34 senses water pressure within the water feed pipe 36 in connection with water pressure within the storage tank 300, converts the sensed water pressure into an electrical signal and outputs the converted electrical signal to the control unit 16. If the water pressure sensed by the pressure sensor 34 varies instantaneously and abruptly a predetermined number of times (for example, five times) or more each for predetermined periods of time t2, t3 and t4, the control unit 16 outputs the first control signal to the electronic switch 17 to interrupt power to the pumping unit 22. After predetermined periods of time t5, t6 and t7 elapse from a time point of interruption of power to the pumping unit 22, respectively, the control unit 16 outputs the second control signal to the electronic switch 17 to supply power to the pumping unit 22 so as to resume the pumping operation. If the water pressure sensed by the pressure sensor 34 increases and then exceeds the predetermined value p3 for a predetermined period of time t8, the control unit 16 outputs the first control signal to the electronic switch 17 to interrupt power to the pumping unit 22.

As seen from the graph of FIG. 7, in the initial condition where the intake chamber 24, main controller 100, water feed pipe 36 and water storage tank 300 are installed, the water pressure sensed by the water pressure sensor 34 begins with p0 when raw water is intaken from the intake chamber 24. Thereafter, the pumping unit 22 is automatically driven at the moment that the sensed water pressure reaches the value p1 indicative of the low water level after raw water is intaken from the intake chamber 24. The pumping unit 22 performs an initial pumping operation at pressure p2, and the water feed pipe 36 preferably has a sufficient strength to withstand the initial pumping pressure p2. Water pressure within the pipe 36 will increase gradually, and then vary instantaneously and abruptly when the amount of raw water capable of being intaken from the intake chamber 24 is limited. At this time, if the water pressure sensed by the pressure sensor 34 varies instantaneously and abruptly a predetermined number of times or more for each of the predetermined periods of time t2, t3 and t4, the control unit 16 controls the electronic switch 17 to interrupt power to the pumping unit 22 so as to stop the pumping operation. Then, the water pressure sensor 34 senses water pressure within the water storage tank 300, and the control unit 16 stops the operation of the pumping unit 22 for each of the predetermined periods of time t5, t6 and t7. After the predetermined periods of time t5, t6 and t7 elapse, respectively, the control unit 16 controls the electronic switch 17 to supply power to the pumping unit 22 so as to resume the pumping operation. In this manner, raw water can be continuously stored into the water storage tank 300. If the water pressure sensed by the pressure sensor 34 increases and then exceeds the high water level pressure value p3 for the predetermined period of time t8, the control unit 16 controls the electronic switch 17 to interrupt power to the pumping unit 22. As a result, because of no water pumped out by the pumping unit 22, the water pressure sensor 34 senses only water pressure within the storage tank 300. At this time, the sensed water pressure will have the value ps lower than the high water level pressure value p3. Thereafter, at the time that the sensed water pressure reaches the low water level pressure value p1 as raw water stored within the storage tank 300 is consumed, the control unit 16 controls the electronic switch 17 to supply power to the pumping unit 22, thereby causing the water pressure sensor 34 to sense water pressure within the water feed pipe 36.

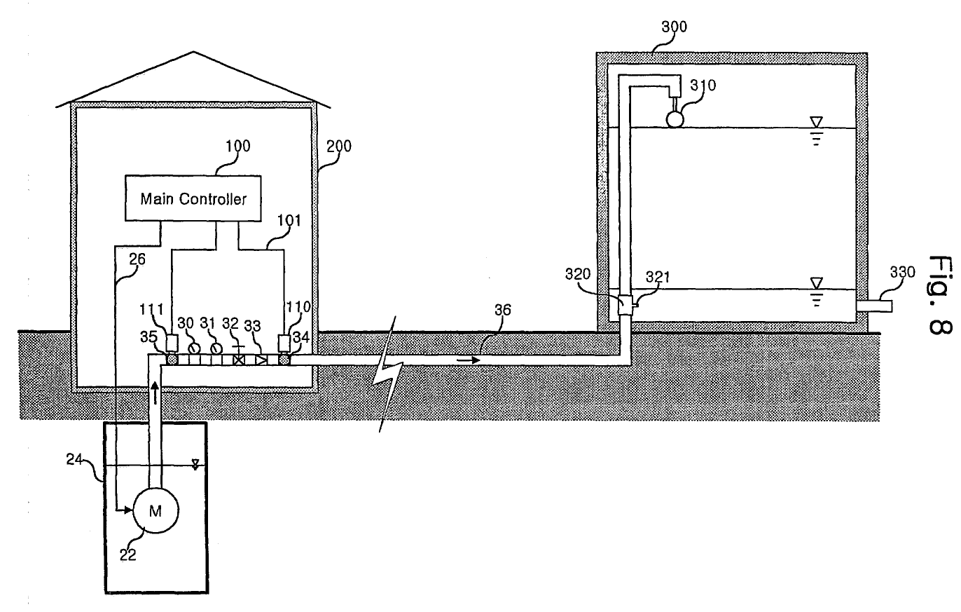

FIG. 8 is a view showing a third embodiment of the automatic wireless water level control system in accordance with the present invention. In the third embodiment of FIG. 8, at least two water pressure sensors, a first water pressure sensor 34 and a second water pressure sensor 35, are provided in the water feed pipe 36, and a check valve 33 is installed between the first and second water pressure sensors 34 and 35. The first water pressure sensor 34 functions to sense pressure of raw water intaken from the intake chamber 24, and the second water pressure sensor 35 functions to sense water pressure within the water feed pipe 36 in connection with water pressure within the storage tank 300. Each of the first and second water pressure sensors 34 and 35 converts the sensed water pressure into an electrical signal and outputs the converted electrical signal to the control unit 16.

In other words, the first water pressure sensor 34 is mounted on the water feed pipe 36 to sense only pressure of raw water intaken from the intake chamber 24 and output the resulting sense signal to the control unit 16, and the second water pressure sensor 35 is mounted on the water feed pipe 36 to sense only water pressure within the pipe 36 in connection with water pressure within the storage tank 300 and output the resulting sense signal to the control unit 16.

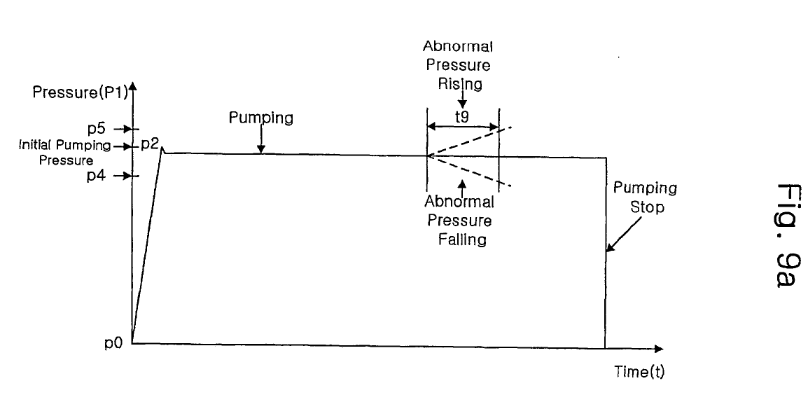

FIG. 9a is a graph illustrating a pressure (P1) to time (t) relation of the first water pressure sensor 34, and FIG. 9b is a graph illustrating a pressure (P2) to time (t) relation of the second water pressure sensor 35.

Assume that an unrestricted amount of raw water is intaken from the intake chamber 24 under the condition that the first and second water pressure sensors 34 and 35 are mounted on the water feed pipe 36. The first water pressure sensor 34 is adapted to sense only the predetermined pressure p2 of raw water pumped out by the pumping unit 22, as seen from FIG. 9a. If the water pressure sensed by the first water pressure sensor 34 is maintained below a predetermined value p4 or above a predetermined value p5 for a predetermined period of time t9, the control unit 16 determines that pressure of raw water being intaken from the intake chamber 24 rises or falls abnormally, and then outputs the first control signal to the electronic switch 17 to interrupt power to the pumping unit 22.

The second water pressure sensor 35 is adapted to sense only water pressure within the water feed pipe 36 in connection with water pressure within the storage tank 300, irrespective of pressure of raw water being intaken from the intake chamber 24, as seen from FIG. 9b. If the water pressure sensed by the second water pressure sensor 35 is maintained above the predetermined value p3 for a predetermined period of time t10, the control unit 16 controls the electronic switch 17 to interrupt power to the pumping unit 22. Also, if the water pressure sensed by the second pressure sensor 35 is below the predetermined value p1, the control unit 16 controls the electronic switch 17 to supply power to the pumping unit 22. In the case where no water is pumped out by the pumping unit 22, the second water pressure sensor 35 senses only water pressure within the storage tank 300. At this time, the sensed water pressure will have the value ps lower than the value p3 indicative of the high water level. Thereafter, raw water stored within the storage tank 300 is consumed.

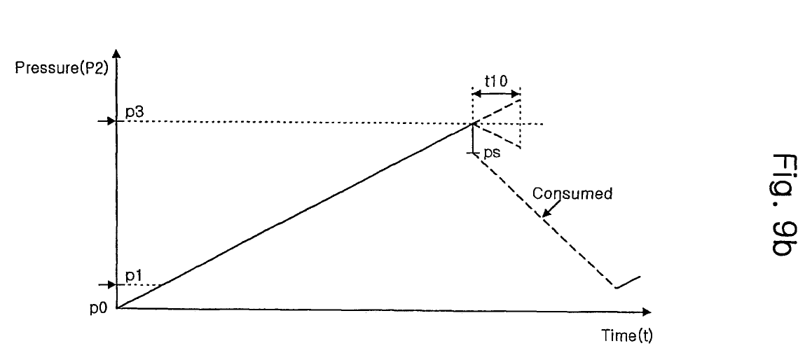

FIG. 10 is a view showing a fourth embodiment of the automatic wireless water level control system in accordance with the present invention. In the fourth embodiment of FIG. 10, at least two water pressure sensors, the first water pressure sensor 34 and the second water pressure sensor 35, are provided in the water feed pipe 36, and a limited amount of raw water is intaken from the intake chamber 24.

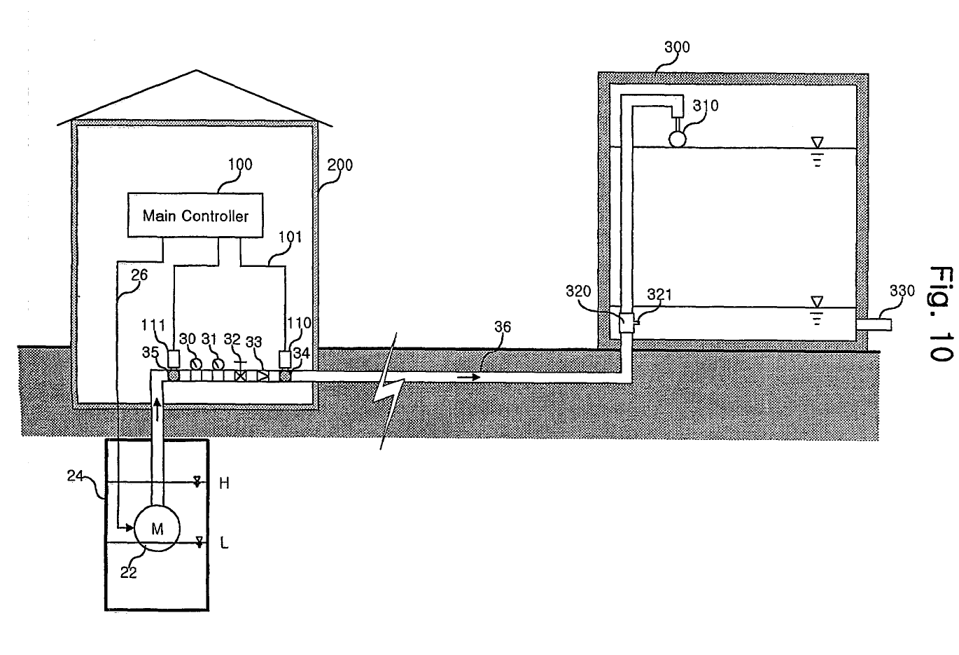

FIG. 11a is a graph illustrating a pressure (P1) to time (t) relation of the first water pressure sensor 34, and FIG. 11b is a graph illustrating a pressure (P2) to time (t) relation of the second water pressure sensor 35.

First, the first water pressure sensor 34 senses initial pumping pressure of raw water being intaken from the intake chamber 24 by the intake pumping unit 22. Then, the first pressure sensor 34 continuously senses pressure of raw water being intaken from the intake chamber 24. If the water pressure sensed by the first water pressure sensor 34 varies instantaneously and abruptly a predetermined number of times or more each for predetermined periods of time t11, t12 and t13, the control unit 16 determines that raw water is not normally pumped out from the intake chamber 24 and then interrupts power to the pumping unit 22 to stop the pumping operation. After predetermined periods of time t14, t15 and t16, for which raw water is filled in the intake chamber 24 to a normal level, elapse from a time point of interruption of power to the pumping unit 22, respectively, the control unit 16 outputs the second control signal to the electronic switch 17 to supply power to the pumping unit 22 so as to resume the pumping operation. Thereafter, if the water pressure sensed by the first water pressure sensor 34 rises or falls abnormally for a predetermined period of time t17 while raw water is normally pumped out from the intake chamber 24, the control unit 16 interrupts power to the pumping unit 22. The abnormal rising or falling of the sensed pressure may result from, for example, a fault in the pumping unit 22 or a choking of the water feed pipe 36. For the abnormal rising or falling of the sensed pressure, the control unit 16 stops the pumping operation to protect the pumping unit 22 and water feed pipe 36.

The second water pressure sensor 35 is adapted to sense pressure of raw water which is pumped out by the intake pumping unit 22 and then fed to the water storage tank 300 through the water feed pipe 36. Pressure of raw water being intaken from the intake chamber 24 gradually increases beginning with the initial pumping pressure p2 as the pumping unit 22 is driven. Then, the second water pressure sensor 35 senses only water pressure within the water feed pipe 36 in connection with water pressure within the water storage tank 300 each for non-pumping periods of time t18, t19 and t20 after the control unit 16 stops the operation of the pumping unit 22 in response to an output signal from the first water pressure sensor 34. If the water pressure sensed by the second water pressure sensor 35 is maintained above a predetermined value p8 for a predetermined period of time t21, the control unit 16 outputs the first control signal to the electronic switch 17 to interrupt power to the pumping unit 22 so as to stop the operation thereof. This situation signifies that the storage of raw water within the water storage tank 300 has been completed. In the case where the intaking operation of raw water is ended, the second water pressure sensor 35 senses only water pressure within the storage tank 300 because of no water pumped out by the pumping unit 22. At this time, the sensed water pressure will have the value ps lower than the value p3 indicative of the high water level. Thereafter, raw water stored within the storage tank 300 is consumed. At the time that the sensed water pressure within the water feed pipe 36 reaches the value pl indicative of the low water level as raw water stored within the storage tank 300 is consumed, the control unit 16 controls the electronic switch 17 to supply power to the pumping unit 22 so as to run it.

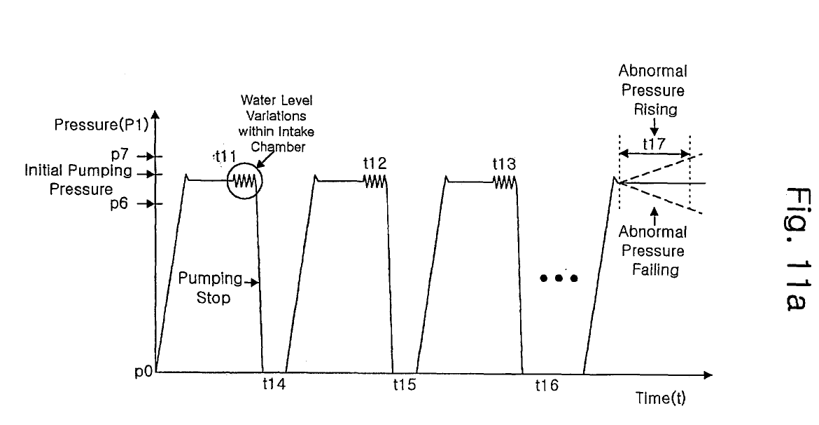

FIG. 12 is a view showing a fifth embodiment of the automatic wireless water level control system in accordance with the present invention. In the fifth embodiment of FIG. 12, one water pressure sensor 34 is provided in the water feed pipe 36 to sense water pressure within the pipe 36 in connection with water pressure within the water storage tank 300, and a pneumatic pipe 37 and pneumatic sensor (second pressure sensor) 35 are provided in the intake chamber 24 to sense a water level within the chamber 24. Also in this fifth embodiment, a limited amount of raw water is intaken from the intake chamber 24, and the intake pumping unit 22 is stopped in operation if little raw water is pumped out from the chamber 24, and resumed in operation if the level of raw water within the chamber 24 returns to a predetermined value.

The use of the pneumatic pipe 37 and pneumatic sensor 35 to sense the water level within the intake chamber 24 can prevent the intake pumping unit 22 from excessively running.

In other words, if the water level within the intake chamber 24 is high (H), the pumping unit 22 can readily pump raw water from the chamber 24 to the water storage tank 300 through the water feed pipe 36. However, if the water level within the intake chamber 24 becomes low (L) as raw water is discharged from the chamber 24, the pumping unit 22 cannot normally pump out the chamber 24. In the case where the water level within the intake chamber 24 is high, air within the pneumatic pipe 37 is compressed by atmospheric pressure, resulting in an increase in air pressure being applied to the pneumatic sensor 35. Then, the pneumatic sensor 35 senses the applied air pressure and outputs the resulting sense signal to the main controller 100 via the drive controller 110. The main controller 100 compares an output value from the pneumatic sensor 35 with a reference value, determines from the compared result that the water level within the intake chamber 24 is high (H), and then continues to supply a drive voltage to the pumping unit 22. However, if the water level within the intake chamber 24 is lowered, air pressure in the pneumatic pipe 37 is reduced, and the pneumatic sensor 35 senses the reduced air pressure and outputs the resulting sense signal to the main controller 100 via the drive controller 110. The main controller 100 compares an output value from the pneumatic sensor 35 with a reference value, determines from the compared result that the water level within the intake chamber 24 is low (L), and then interrupts the drive voltage to the pumping unit 22 so as to stop the pumping operation.

Accordingly, the pumping unit 22 is normally driven only when the water level within the intake chamber 24 is higher than the low level L. In the case where the pumping unit 22 normally performs the pumping operation, the drive voltage thereto is constant in level, too. But, if the pumping unit 22 pumps out a smaller amount of raw water from the intake chamber 24 as the water level within the chamber 24 becomes lower, the drive voltage thereto becomes lower in level.

As a result, with no necessity for sensing the amount of raw water within the intake chamber 24 through the pneumatic sensor, or second pressure sensor, 35, the main controller 100 can analyze the level of the drive voltage to the pumping unit 22 and determine on the basis of the analyzed result whether little water is present within the chamber 24.

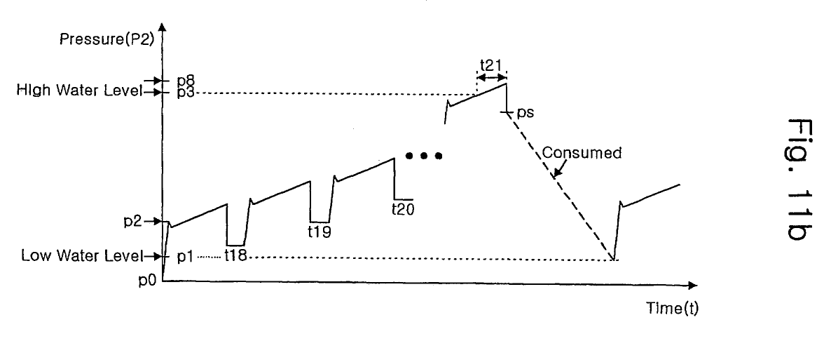

FIG. 13a is a graph illustrating a procedure for initially setting the control unit 16 in the main controller 100 to a variety of reference values of the water level within the water storage tank 300 and controlling the operation of the pumping unit 22 on the basis of the set reference values without re-settings. First, at the time that raw water is intaken and fed to the water storage tank 300 and then filled to a desired level a, the user stops the operation of the pumping unit 22. After the operation of the pumping unit 22 is stopped, the user sets the pressure p3 indicative of the high water level as an initial value b. If the initial value is set, then raw water is fed through the water feed pipe 330 to the storage tank 300. At the time that the water level within the storage tank 300 reaches the low level indicated by the pressure p1, the operation of the pumping unit 22 is started. Then, the low level indicated by the pressure p1 is set as a pumping start value c. At the moment that raw water is filled within the storage tank 300 to the high level indicated by the pressure p3 as the pumping unit 22 is driven, the operation of the pumping unit 22 is stopped at an OFF value d. The initial value b, pumping start value c and OFF value d are set on the basis of values, or pressures, sensed by the water pressure sensor 34.

FIG. 13b is a graph illustrating an exemplary operation of a general pressurized water tank. In this drawing, the generation of ripple components e in the OFF value d signifies that raw water is not normally fed from the pressurized water tank. FIG. 13c is a graph illustrating an exemplary operation of a general well. As shown in this drawing, if the water level within the intake chamber is lower than a reference value, the sensed pressure varies a large number of times for a given period of time, as indicated by f, because it cannot completely return to a normal value after falling instantaneously and abruptly. At the time that the sensed pressure completely returns to the normal value, the pumping operation can be normally resumed.

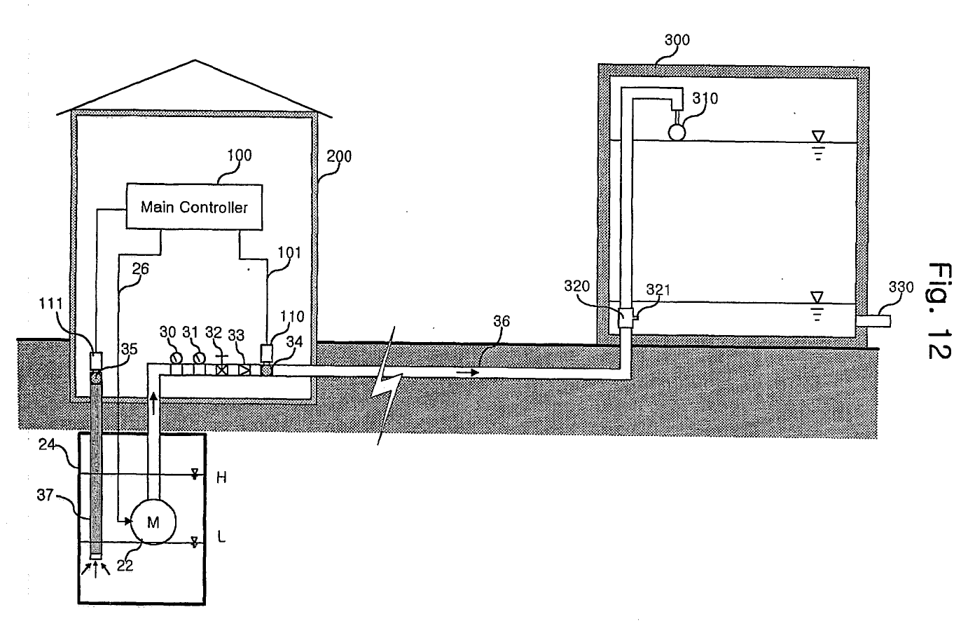

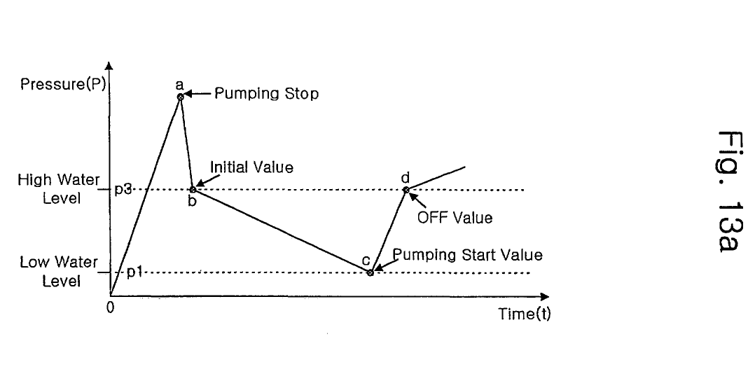

FIG. 14 is a view showing a first embodiment of a structure for more accurately sensing the level of raw water stored within the water storage tank 300 via the water feed pipe 36 in accordance with the present invention. As stated previously, the T-shaped pipe coupling 320 is provided at the lower portion inside the water storage tank 300. The T-shaped pipe coupling 320 has the inlet port connected to the end of the water feed pipe 36, and the outlet port connected to the float 310 via the discharge pipe. The water pressure sensing pipe 321 extends from the intermediate point between the inlet and outlet ports of the coupling 320. A flared tube 322 is formed at the end of the pipe 321 to sense pressure, more particularly atmospheric pressure, of raw water within the storage tank 300 and transfer the sensed water pressure to the water pressure sensor 34 through the water feed pipe 36. The flared tube 322 is preferably positioned in the storage tank 300 in the opposite direction to the water feed pipe 330 or in such a manner that it is little influenced by the pipe 330. FIG. 15 is a view showing a second embodiment of the structure for sensing the level of raw water stored within the water storage tank 300 via the water feed pipe 36 in accordance with the present invention, wherein the water pressure sensing pipe 321 and flared tube 322 are positioned within the storage tank 300 as far as possible from the water feed pipe 36.

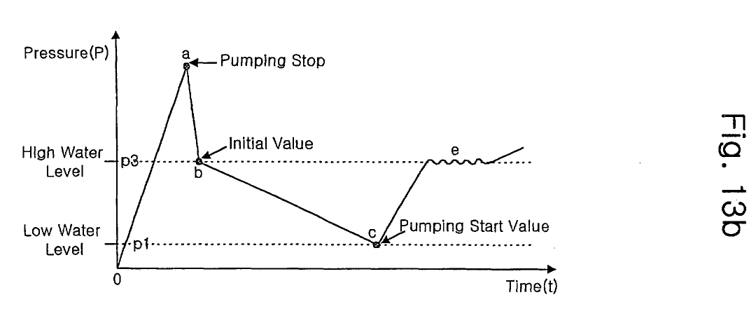

FIG. 16 is a view showing a third embodiment of the structure for sensing the level of raw water stored within the water storage tank 300 via the water feed pipe 36 in accordance with the present invention, wherein a separate internal pipe 325 is inserted into the water feed pipe 36. In this structure, the internal pipe 325 senses water pressure within the storage tank 300 for more accurate detection of the water level within the tank 300 while the pipe 36 feeds raw water to the tank 300.

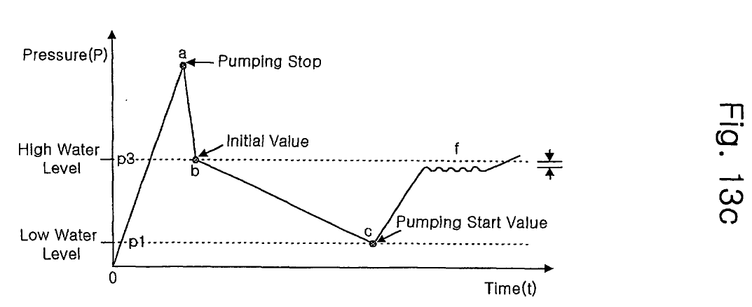

FIG. 17 is a view showing a structure of the float 310 connected to the end of the water feed pipe 36 via the T-shaped pipe coupling 320 and discharge pipe in accordance with the present invention. In this drawing, the float 310 is shown to be not spherical but conical so as to minimize a fluctuation or motion of raw water within the storage tank 300, thereby making it possible to more accurately sense the set high water level.

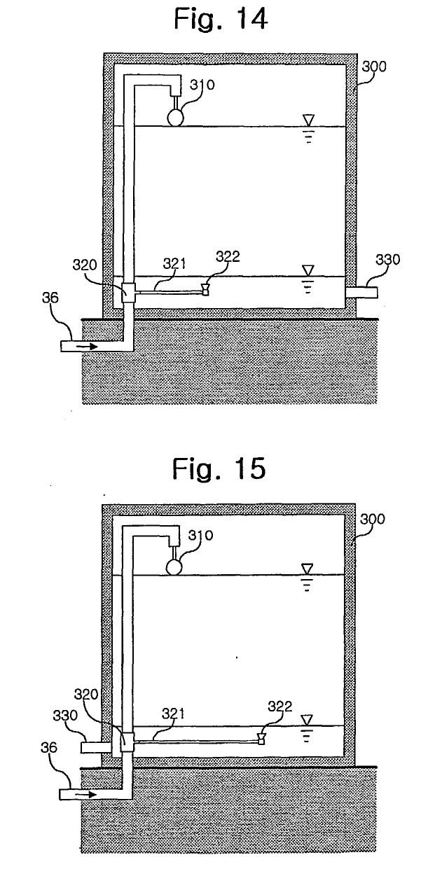

FIG. 18 is a view showing a structure of an auxiliary pipe 324 for sensing water pressure within the water storage tank 300 in accordance with the present invention. As shown in this drawing, the auxiliary pipe 324 extends from the flared tube 322 formed at the end of the water pressure sensing pipe 321. A plurality of water pressure holes 323 are formed in the auxiliary pipe 324 to accurately sense water pressure within the storage tank 300 against a fluctuation or motion of raw water within the storage tank 300 resulting from water feeding through the water feed pipe 330, etc.

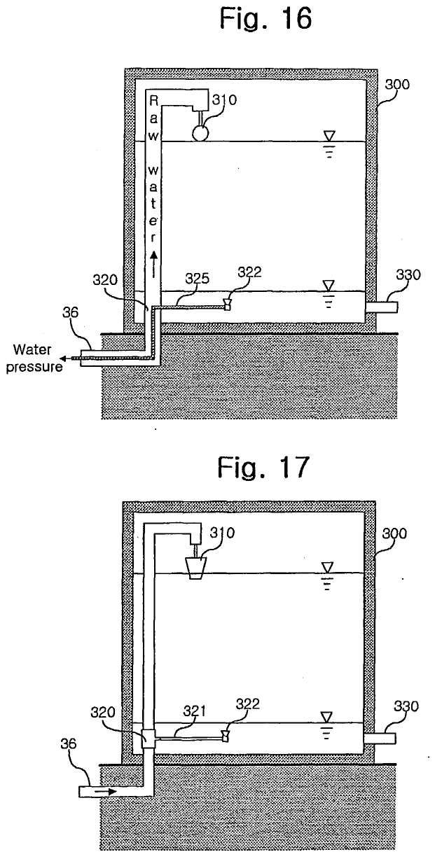

FIG. 19 is a flowchart illustrating the operation of the pumping unit 22 in the automatic mode in accordance with the present invention, which is controlled by the main controller 100. First, if the main controller 100 is powered on at step S10, then a lamp of the mode setting key 51 is turned on and the operation mode enters the automatic mode. Alternatively, the operation mode can be changed from the manual mode to the automatic mode by pushing the mode setting key 51 and then turning on the lamp of the key 51.

If the operation mode enters the automatic mode, then the red lamp of the motor setting key 52 is turned on and the electronic switch 17 connects its common contact to its fixed contact A to drive the pumping unit 22, at step S11. The control unit 16 in the main controller 100 waits for a start delay period of time at step S12 and then senses water pressure within the water feed pipe 36 at an interval of a predetermined period of time, for example, one second. At step S13, the control unit 16 compares the sensed water pressure value with a water pressure value sensed 16 seconds before to determine whether it is higher than the water pressure value sensed 16 seconds before. If the sensed water pressure value is determined to be higher than the water pressure value sensed 16 seconds before from the compared result, the control unit 16 recognizes that the water pressure within the water feed pipe 36 has risen.

The control unit 16 determines at step S14 whether the water pressure within the water feed pipe 36 rises continuously for an end delay period of time. Upon determining at step S14 that the water pressure within the water feed pipe 36 rises continuously for the end delay period of time, the control unit 16 recognizes that the water level within the water storage tank 300 is high, and thus turns off the lamp of the motor setting key 52 and stops the operation of the pumping unit 22, at step S16. However, if it is determined at the above step S14 that the water pressure within the water feed pipe 36 does not rise continuously for the end delay period of time, the control unit 16 maintains the operation of the pumping unit 22 as it is, at step S15.

At step S17, the control unit 16 maintains the pumping unit 22 in a standby mode for a pressure stabilization delay period of time (for example, 2 minutes) after the operation of the pumping unit 22 is stopped. At step S18, the lamp of the water level display means 46 is lighted to display ‘Full’ after the pressure stabilization delay period of time elapses. At this time, the control unit 16 calculates a low water level value on the basis of a displayed water pressure value and a value set by the level setting key 53. Namely, low water level (cm)=(pressure value in full state×1000) (cm)−value (cm) set by level setting key.

In the case where it is determined at the above step S18 that the current water level within the water storage tank 300 is higher than the low water level, the control unit 16 maintains the operation of the pumping unit 22 as it is, at step S19. On the contrary, if it is determined at the above step S18 that the current water level within the water storage tank 300 is lower than or equal to the low water level, the control unit 16 resumes the operation of the pumping unit 22.

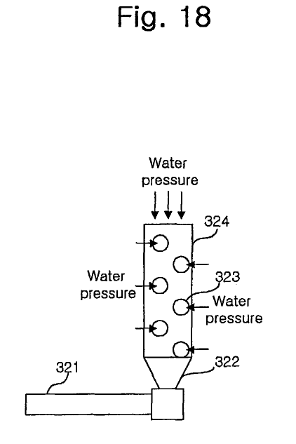

FIG. 20 is a flowchart illustrating the operation of the pumping unit 22 in the automatic mode in accordance with the present invention under the condition that a limited amount of raw water is fed to the water storage tank 300, which is controlled by the main controller 100. First, if the main controller 100 is powered on at step S20, then the lamp of the mode setting key 51 is turned on and the operation mode enters the automatic mode. Alternatively, the operation mode can be changed from the manual mode to the automatic mode by pushing the mode setting key 51 and then turning on the lamp of the key 51.

If the operation mode enters the automatic mode, then the red lamp of the motor setting key 52 is turned on and the electronic switch 17 connects its common contact to its fixed contact A to drive the pumping unit 22, at step S21. The control unit 16 in the main controller 100 waits for a start delay period of time at step S22 and then checks a pressure variation, or a low to high pressure transition or high to low pressure transition, at step S23 to determine whether it is greater than or equal to a predetermined value, for example, 0.1 kg/cm². If the pressure variation is greater than or equal to 0.1 kg/cm², the control unit 16 counts down one. Upon continuously counting down up to a predetermined number, for example, 60 or more, the control unit 16 stops the operation of the pumping unit 22. On the contrary, in the case where the pressure variation is smaller than 0.1 kg/cm², the control unit 16 regards the current pressure as a normal pressure and thus counts up one whenever the normal pressure is maintained constant for a predetermined period of time, for example, 5 seconds or more.

As a result, unless the great pressure variation occurs continuously the predetermined number of times, the control unit 16 continuously maintains the pumping unit 22 ON at step S24. At step S25, the control unit 16 maintains the pumping unit 22 in the standby mode for a predetermined re-set period of time after the operation of the unit 22 is stopped, and then resumes the operation of the unit 22.

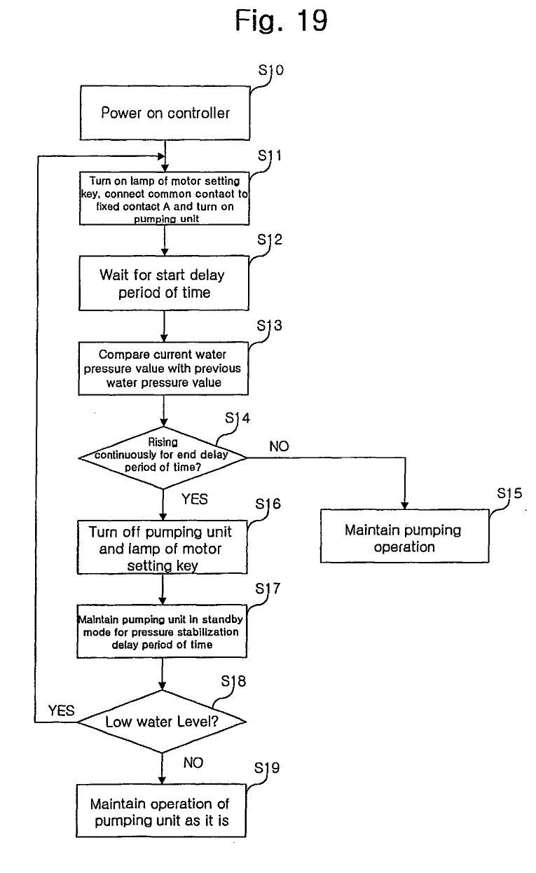

FIG. 21 is a flowchart illustrating the operation of the pumping unit 22 in the manual mode in accordance with the present invention, which is controlled by the main controller 100. First, if the main controller 100 is powered on at step S30, then the lamp of the mode setting key 51 is turned on and the operation mode enters the automatic mode. The operation mode is then changed from the automatic mode to the manual mode by pushing the mode setting key 51 and then turning off the lamp of the key 51. This change of the operation mode to the manual mode is made for operating the pumping unit 22 at a user's discretion. The control unit 16 in the main controller 100 determines at step S31 whether the drive switch for the pumping unit 22, or the electronic switch 17, is ON. If it is determined at step S31 that the electronic switch 17 is ON, the control unit 16 connects the common contact of the switch 17 to the fixed contact A at step S32. However, in the case where it is determined at step S31 that the electronic switch 17 is not ON, the control unit 16 connects the common contact of the switch 17 to the fixed contact B at step S33.

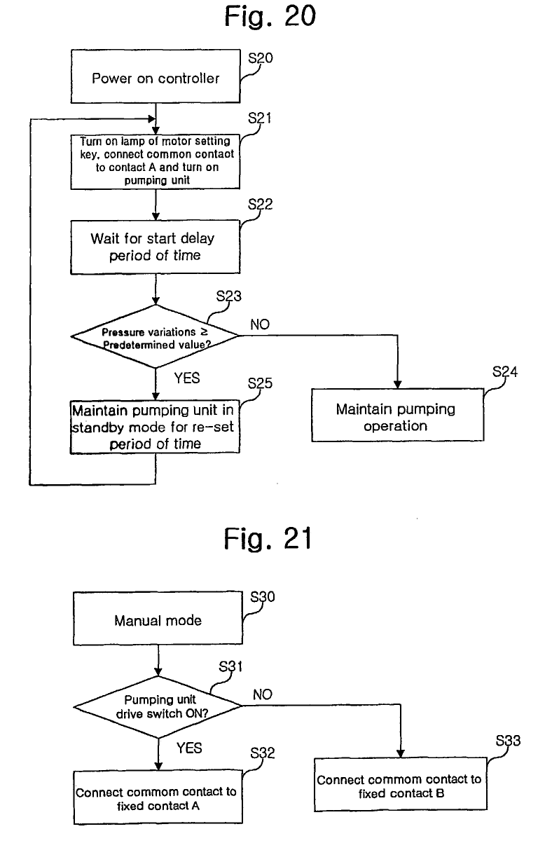

FIG. 22 is a flowchart illustrating the operation of the main controller 100 in accordance with the present invention. First, if the water pressure sensor 34 outputs a sense signal at step S40, then an operational amplifier (OP-AMP) amplifies the sense signal by a predetermined level at step S41 and a voltage/frequency converter converts an output voltage from the amplifier into a frequency value at step S42. The control unit 16 performs an arithmetic operation for the converted frequency value from the voltage/frequency converter and outputs a control signal as a result of the arithmetic operation at step S43. Then, the control unit 16 displays a water pressure value sensed by the water pressure sensor on the display window 40 of the control panel 12 at step S44 and controls the operation of the pumping unit 22 at step S45 by controlling the contacts of the electronic switch 17.

At least one of the first and second pressure sensors 34 and 35 is used to sense a water level within the water storage tank 300 and a water level within the intake chamber 24 and provide the resulting sense data to the control unit 16. Then, the control unit 16 controls the electronic switch 17 in response to the received sense data to supply power to the intake pumping unit 22. As a result, the pumping unit 22 is driven to pump out raw water from the intake chamber 24.

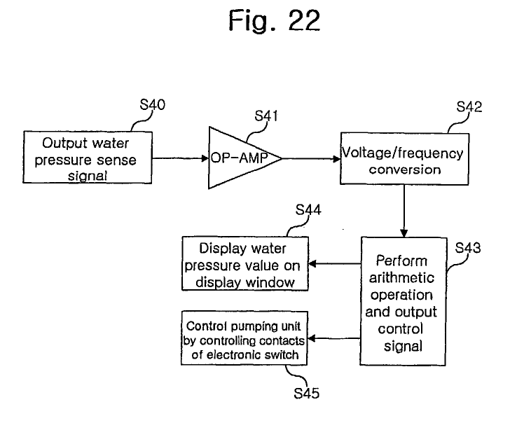

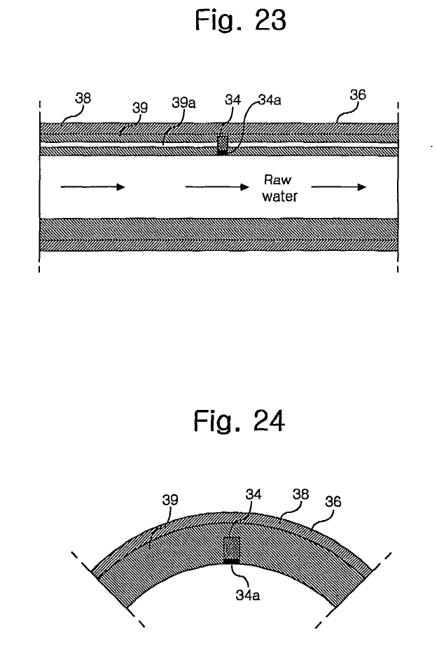

FIG. 23 is a sectional view illustrating the installation of the water pressure sensor 34 within the water feed pipe 36 in accordance with the present invention. As shown in this drawing, the water pressure sensor 34 is provided within an internal pipe 39 of the water feed pipe 36 or formed integrally with the pipe 36 therein. That is, the water pressure sensor 34 is provided within the internal pipe 39 of the water feed pipe 36 such that it senses water pressure within the pipe 36 without obstructing the flow of raw water within the pipe 36. The pressure sensor 34 has a sensing element 34a, which is preferably mounted on the inner surface of the water feed pipe 36. In other words, as shown in FIG. 24, the water feed pipe 36 consists of an external pipe 38 and the internal pipe 39 in which the water pressure sensor 34 is provided. A sense signal from the water pressure sensor 34 is transferred to the control unit 16 in the main controller 100 through the internal pipe 39 of the water feed pipe 36.

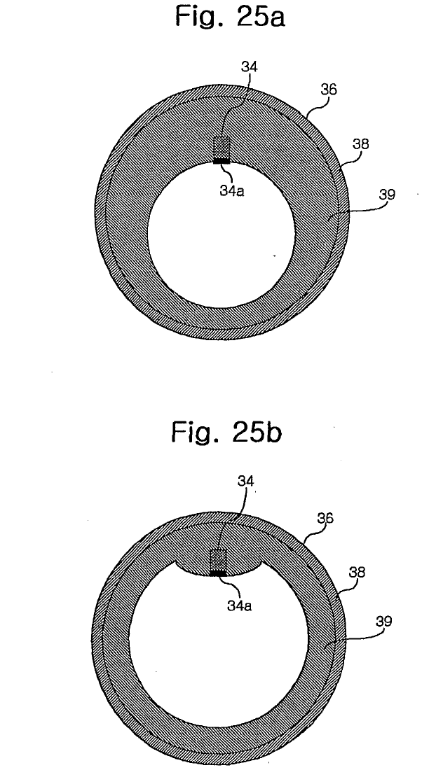

The water pressure sensor 34 may be installed in different forms depending on sections secured by the water feed pipe 36. In particular, the pressure sensor 34 may preferably be installed in forms as shown in FIGS. 25a to 25d. In FIG. 25a, the water pressure sensor 34 is mounted on a thick section portion of the water feed pipe 36. In FIG. 25b, the water pressure sensor 34 is mounted on a convex portion of the inner surface of the water feed pipe 36. In FIG. 25c, the water pressure sensor 34 is mounted on a convex portion of the outer surface of the water feed pipe 36. In FIG. 25d, the water pressure sensor 34 is mounted on the outer surface of the water feed pipe 36, whereas the sensing element 34a of the sensor 34 is mounted on the surface of the internal pipe 39.

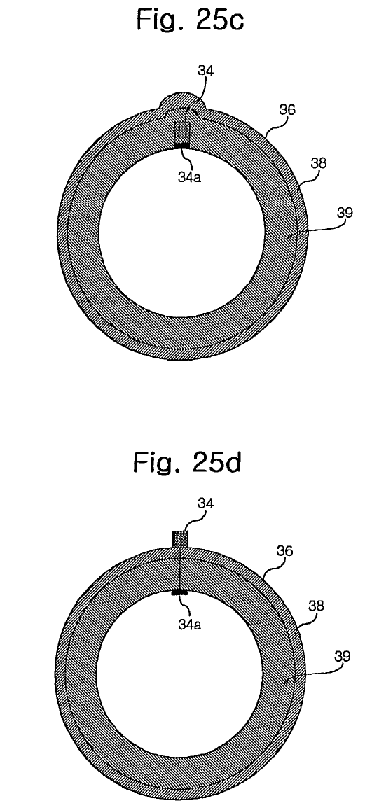

FIG. 26 is a schematic view showing connections of a plurality of pumping units 22 and a plurality of water feed pipes 36 to one water storage tank 300 in accordance with the present invention. In this drawing, the first water pressure sensor 34 (or the second water pressure sensor 35 in the construction including the first and second pressure sensors 34 and 35) is mounted on each of the water feed pipes 36 to sense water pressure within each pipe 36 and output the sensed pressure value to the control unit 16 in the main controller 100. In response to each pressure value from the water pressure sensor, the control unit 16 displays each water amount or level value on the display window 40 of the control panel 12 and stores it in the memory 18.

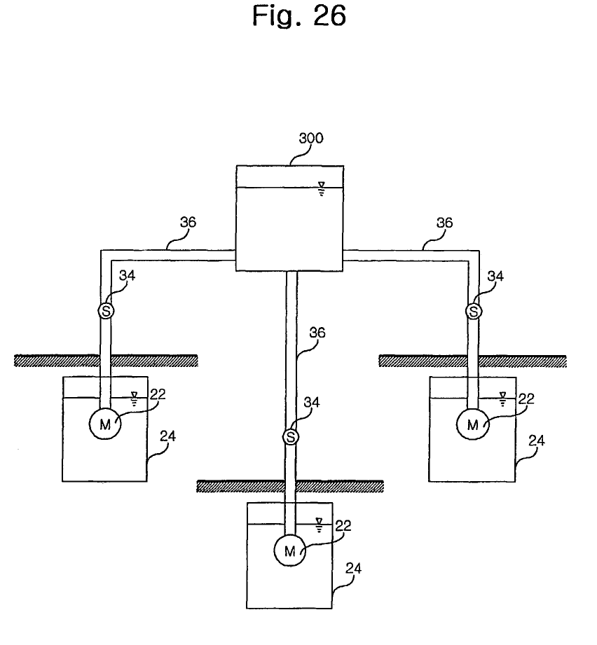

In the case where one pumping unit 22 and a plurality of water feed pipes 36 are connected to a plurality of water storage tanks 300, as shown in FIG. 27, the first water pressure sensor 34 or second water pressure sensor 35 is mounted on each of the water feed pipes 36 to sense water pressure within each pipe 36 and output the sensed pressure value to the control unit 16 in the main controller 100. In response to each pressure value from the water pressure sensor, the control unit 16 displays each water amount or level value on the display window 40 of the control panel 12 and stores it in the memory 18.

In other words, in FIGS. 26 and 27, the first or second water pressure sensor 34 or 35 is mounted on each of the water feed pipes 36 to sense the amount of raw water fed through each pipe.

In the automatic wireless water level control system with the above-stated construction in accordance with the present invention, the control unit 16 in the main controller 100 can control the intake pumping unit 22 on the basis of the user's settings on the control panel 12 in the main controller 100 in the case where the intake chamber 24 in which the pumping unit 22 is installed is disposed apart from the water storage tank 300 at a certain distance.

The pumping unit 22 is controlled in the case where the amount or level of raw water within the intake chamber 24 is lower than a predetermined value and where the amount or level of raw water within the water storage tank 300 is higher than a predetermined value.

That is, the user can run the pumping unit 22 in the manual mode or automatic mode by operating the control panel 12. In the manual mode, the user can compulsorily turn on or off the pumping unit 22 by operating the mode setting key 51 in the function key input unit 50. At this time, the pumping unit 22 can be automatically driven according to data set through the mode setting key 51 or the result sensed by the water pressure sensor 34. Hence, the user can personally start or stop the operation of the pumping unit 22 by setting the mode setting key 51 to the manual mode and operating the motor setting key 52.

If the user pushes desired keys in the selection key input unit 60 in the automatic mode, then the main controller 100 ignores the previous procedure and performs the control operation on the basis of values set by the user and then stored. A plurality of control cycles (for example, 15 cycles) are repeated in the case where the second water pressure sensor 35 is turned on at a high water level in the automatic mode. Provided that the second water pressure sensor 35 still remains ON at the high water level, the automatic mode is performed for a number of control cycles twice the number of the previous control cycles. Nevertheless, in the case where the second water pressure sensor 35 still remains ON at the high water level, the main controller 100 turns off all functions of the system until there is present an external input. Alternatively, if the second water pressure sensor 35 is turned off at the high water level for the set number of control cycles, the main controller 100 drives the pumping unit 22 and then proceeds to the next procedure. Provided that the second water pressure sensor 35 is turned on at the high water level even when the pumping unit 22 is in operation, the main controller 100 turns off the pumping unit 22 and then proceeds to the next procedure.

In the manual mode, on the basis of not values set by the user and then stored, but the use of the motor setting key 52 by the user, the main controller 100 supplies or interrupts AC power (AC 220V, 60 Hz) to the pumping unit 22 to compulsorily turn it on or off.

In the case where the amount of raw water within the intake chamber 24 is unrestricted, the level of a voltage and the amount of current applied to the pumping unit 22 increase if the water level within the chamber 24 is above a first predetermined value, and decrease if the water level within the chamber 24 is below a second predetermined value. In this connection, the main controller 100 can control the operation of the pumping unit 22 on the basis of the increases or decreases in the voltage level and current amount applied to the pumping unit 22. In other words, the current amount and voltage level applied to the pumping unit 22 are constant when the pumping unit 22 pumps out the intake chamber 24 normally. However, when the pumping unit 22 does not pump out the intake chamber 24 normally, namely, not 100 percent raw water from the chamber 24 is fed, but raw water with air, the current amount and voltage level applied to the pumping unit 22 become lower than those when the pumping unit 22 pumps out the intake chamber 24 normally. As a result, the main controller 100 senses the lower voltage level and current amount and thus stops the operation of the pumping unit 22.

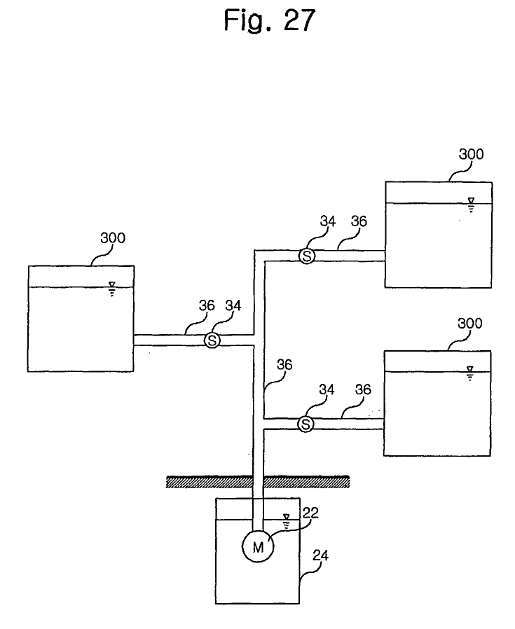

FIG. 28 is a flowchart illustrating the overall operation of the automatic wireless water level control system in accordance with the present invention. First, at step S100, the user installs the intake chamber 24, the water feed pipe 36, the water storage tank 300, the main controller 100 including the control unit 16, the drive controller 110 and at least one water pressure sensor 34 or 35. Then, at step S101, the user drives the intake pumping unit 22 to feed initial raw water from the take chamber 24 to the water storage tank 300 and store it in the storage tank 300.

Under the condition that the initial raw water is stored in the storage tank 300, the user sets high and low levels thereof as initial values at step S102. The following table 1 shows set values corresponding to variable water levels based on values.

TABLE 1

| | PRESSURE | | | |
|---|---|---|---|---|
| | SENSOR | STORAGE | | |
| | (Pressure | TANK | CONTROLLER | |
| CLASS | (kg · f/cm²)) | (Height(m)) | Water Level | Setting |
| 1 | 4.0 | 3.0 | High Level | Initialization |
| 2 | 3.9 | 2.9 | ↑ | · |
| 3 | 3.8 | 2.8 | ↑ | · |
| 4 | 3.1 | 2.7 | ↑ | · |
| 5 | 3.6 | 2.6 | ↑ | · |
| 6 | 3.5 | 2.5 | ↑ | · |
| 7 | 3.4 | 2.4 | ↑ | · |
| . | . | . | . | · |
| . | . | . | . | |
| . | . | . | . | |
| 16 | 2.5 | 1.5 | ↓ | · |
| 17 | 2.4 | 1.4 | ↓ | · |
| . | . | . | ↓ | · |
| . | . | . | | |
| . | . | . | | |
| 28 | 1.3 | 0.3 | ↓ | · |
| 29 | 1.2 | 0.2 | Low Level | 5 Times/min |
| 30 | 1.1 | 0.1 | — | |
| 31 | 1.0 | 0.0 | — | |

Assuming that the user sets a desired high water level to a height of 3 m from the bottom of the water storage tank 300 as in the above table 1 and the current water pressure within the water feed pipe 36 is 4 kg/cm², the control unit 16 in the main controller 100 will judge the water level within the storage tank 300 on the basis of the fact that pressure of 0.1 kg/cm² per 0.1 m is applied. Also, assuming that the user sets a desired low water level to a height of 0.2 m from the bottom of the water storage tank 300 as in the above table 1 and the current water pressure within the water feed pipe 36 is 1.2 kg/cm², the control unit 16 will recognize the current water level within the storage tank 300 as the low level. Herein, the low water level may be either an absolute value or relative value.

Accordingly, the control unit 16 can judge the level of raw water stored in the water storage tank 300 on the basis of the initially set values. It should be noted herein that the above table 1 is given for illustrative purpose. The user can set the high and low water levels to desired values. In the case where the water pressure sensor 34 or 35 more precisely senses pressure up to, for example, 0.001 or less, the high and low water levels may be set to finer values. Even in the case where the water pressure sensor 34 or 35 less precisely senses pressure on the order of 0.1 or more, the high and low water levels may be set to appropriate values.

Under the condition that the initial values are set in the above manner, the control unit 16 senses water pressure within the water storage tank 300 through the water pressure sensor 34 or 35 at step S103 and determines from the sensed water pressure at step S104 whether the current water level within the storage tank 300 is the set low level. In other words, raw water is initially stored within the water storage tank 300 up to the high level and then consumed. At this time, the control unit 16 determines whether the water level within the storage tank 300 has reached the low level set as in the above conversion table 1.

If it is determined at the above step S104 that the current water level within the storage tank 300 is the set low level, the control unit 16 in the main controller 100 controls the electronic switch 17 to supply power to the pumping unit 22. As a result, the pumping unit 22 is driven to pump out raw water from the intake chamber 24 at step S105.

The water pressure sensor 34 or 35 continuously senses pressure of raw water pumped out from the intake chamber 24 at step S106. The control unit 16 determines at step S107 whether the pressure value sensed by the pressure sensor is a predetermined reference value. Upon determining at step 107 that the pressure value sensed by the pressure sensor is lower than or equal to the predetermined reference value under the condition that the amount of raw water in the intake chamber 24 is limited, the control unit 16 recognizes that little water from the chamber 24 is fed and thus interrupts the supply of power to the pumping unit 22 to stop the operation thereof at step S108.

The control unit 16 determines at step S109 whether a predetermined period of time has elapsed after the operation of the pumping unit 22 is stopped. If the predetermined period of time has elapsed, the control unit 16 resumes the pumping operation at step S110. Thereafter, the water pressure sensor 34 or 35 continuously senses water pressure within the water feed pipe 36 in connection with water pressure within the water storage tank 300 at step S111. The control unit 16 determines from the water pressure sensed by the pressure sensor at step S112 whether the current water level within the storage tank 300 has reached the set high level. Upon determining at step S112 that the current water level within the storage tank 300 has reached the set high level, the control unit 16 stops the operation of the pumping unit 22 at step S113.

At this time, the control unit 16 re-sets the current water level within the water storage tank 300 as a new high water level value at step S114 and then continues to sense variations in water pressure within the storage tank 300. That is, if the current water level within the storage tank 300 exceeds the initial high level, the control unit 16 re-sets the current water level as a new high water level value to be used as a benchmark for the subsequent pumping operation. This re-setting operation is performed depending on the sensing capability of the water pressure sensor 34 or 35. In other words, in the case where the water pressure sensor 34 or 35 has a precise sensing capability, the control unit 16 may utilize the initial high water level continuously. However, in the case where the water pressure sensor 34 or 35 has a less precise sensing capability, the control unit 16 can prevent the occurrence of an error resulting from the sensing capability by re-setting a new high water level.

Moreover, after setting the high water level, the control unit 16 recognizes the set high water level a plurality of times (for example, 16 times per sec) for a period of time that water pressure within the water feed pipe 36 is stabilized constant. This high water level setting and recognition process may be performed in different manners according to different sizes of the water storage tank 300 or different pumping capabilities of the intake pumping unit 22. This process is also applicable to general water storage tanks for buildings or homes.

Provided that the amount of raw water within the intake chamber 24 is unrestricted, the control unit 16 will not perform the above steps S108 and S109. It should also be noted that, for two or more water pressure sensors being used, a conversion table such as the above table 1 is applicable to the control unit 16 according to the sensing capabilities of the used pressure sensors.

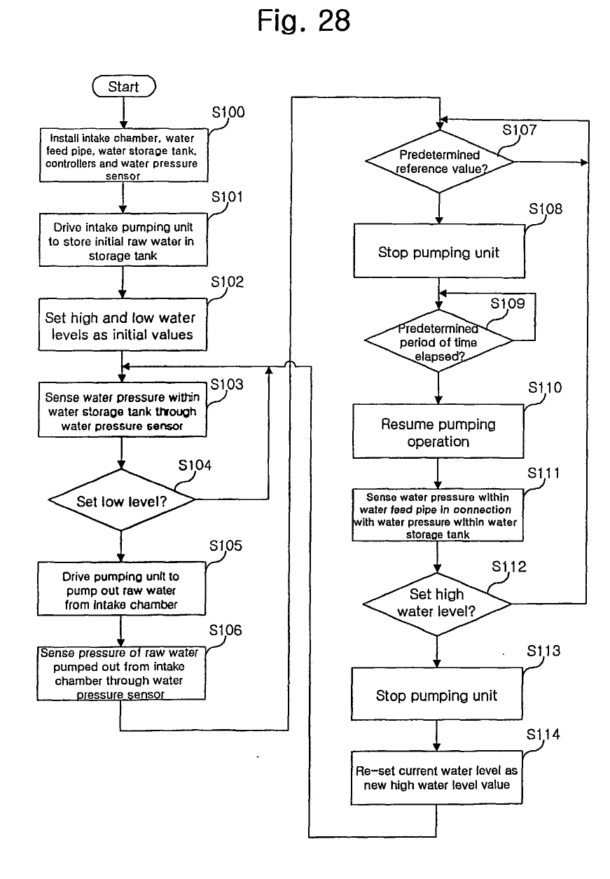

FIG. 29 is a view showing a sixth embodiment of the automatic wireless water level control system in accordance with the present invention, which is implemented to more accurately set high and low levels of raw water stored in the water storage tank 300.

A bypass pipe 71 is connected in parallel to the water feed pipe 36. This bypass pipe 71 branches off from the water feed pipe 36 in the intake control station 200 to utilize raw water fed from the intake chamber 24 directly without storing it in the water storage tank 300. An ON/OFF valve 70 is provided in the bypass pipe 71 to intake or block raw water from the intake chamber 24 according to its ON/OFF operations so as to utilize it separately from raw water stored in the storage tank 300.

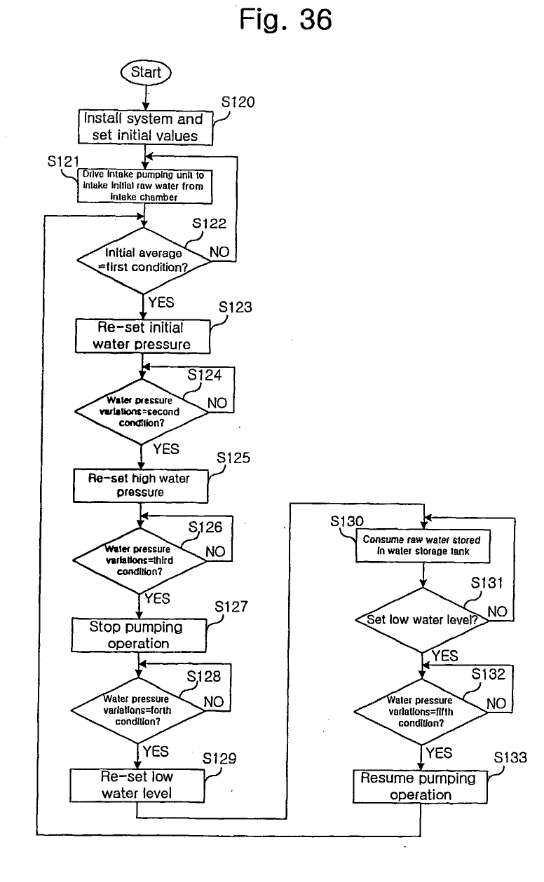

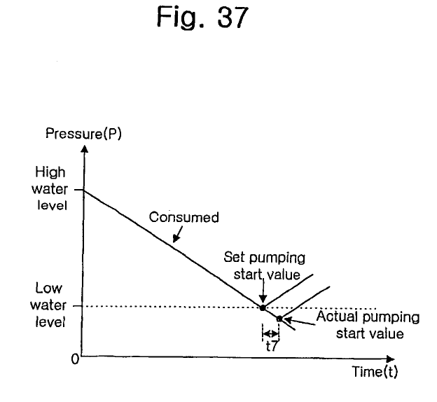

A description will hereinafter be given of an automatic wireless water level control method in accordance with the present invention with reference to a flowchart of FIG. 36, which method is performed by the present automatic wireless water level control system with the above-stated construction.

At the first step S120, the user installs the automatic wireless water level control system and presets a variety of initial values about water pressure within the water storage tank 300, in the memory 18. Namely, at the time that the system installation is completed, the user presets a high level, low level, reference level, stabilized level and average level of raw water to be stored in the storage tank 300, the number of control cycles, a time period of each cycle, etc.

At the second step S121, the main controller 100 drives the intake pumping unit 22 to intake initial raw water from the intake chamber 24. In this case, the main controller 100 outputs the second control signal to the electronic switch 17 under the control of the user to apply a drive voltage to the pumping unit 22. As a result, raw water from the intake chamber 24 is pumped out by the pumping unit 22 and then fed to the water storage tank 300 through the water feed pipe 36.

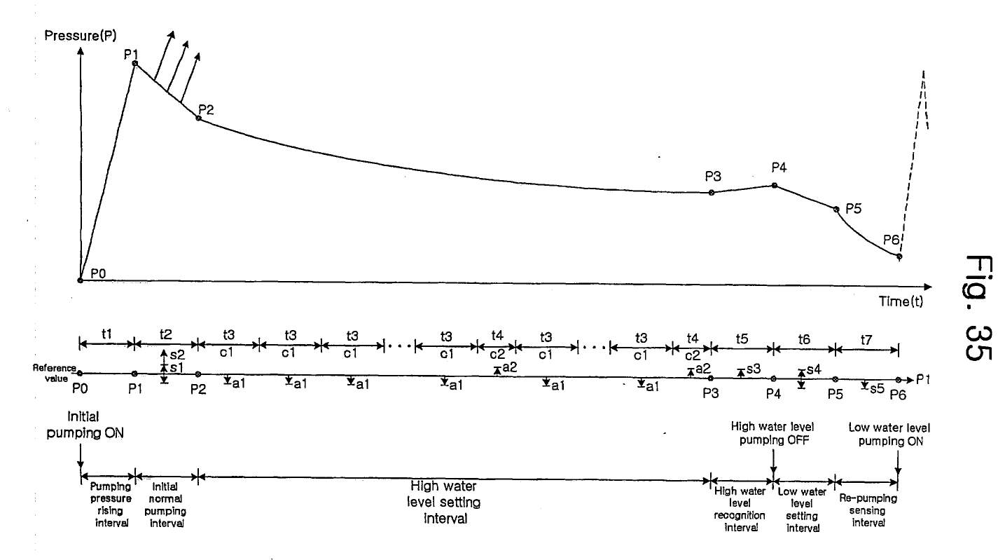

At the third step S122, the main controller 100 senses variations in water pressure within the water feed pipe 36 through the water pressure sensor 34 while raw water pumped out by the pumping unit 22 is fed to the water storage tank 300 through the pipe 36, and then determines whether the sensed water pressure variations satisfy a first condition where a set stable value s1, for example, a value within the range of +0.01 to +0.5 kg/cm², preferably +0.02 kg/cm², is continuously maintained for a predetermined period of time t2 in FIG. 35, for example, a value within the range of 1 second to 5 minutes, preferably 30 seconds. If the first condition is satisfied, the main controller 100 re-sets the average of sensed stable values s1 as an initial pressure value. The main controller 100 also counts a predetermined number (for example, a value within the range of 2 to 32, preferably 16) for the above predetermined period of time t2. If a sensed value, for example, a value above +0.5 kg/cm², is continuously maintained for the predetermined period of time t2, the main controller 100 recognizes the current condition as a pumping OFF condition resulting from an abnormal pressure increase based on the OFF state of an ON/OFF valve 32 or a frozen and burst state of the water feed pipe 36. In this pumping OFF condition, therefore, the main controller 100 stops the operation of the pumping unit 22 to prevent the unit 22 from being overloaded.

On the other hand, if the sensed water pressure variations fall constantly below a predetermined pressure value s2, for example, −0.01 kg/cm² for the predetermined time period t2, the main controller 100 recognizes that raw water from the water feed pipe 36 is in use according to the ON state of the ON/OFF valve 70 in the bypass pipe 71.

FIG. 35 is a graph showing water pressure variations sensed by the water pressure sensor in the automatic wireless water level control method in accordance with the present invention, which are illustrated in the below table 2.

TABLE 2

| PRESSURE | DESCRIPTION |
|---|---|
| P0 | Water pressure at initial ON time of pumping unit |
| P1 | Highest water pressure sensed after initial pumping |
| P2 | Set initial pumping stable value |
| P3 | Set high water level value |
| P4 | Pumping OFF value at high water level |
| P5 | Set low water level value |
| P6 | Pumping restart value at low water level |

The below table 3 describes variations between the water pressure values in the above table 2.

TABLE 2

| PRESSURE | DESCRIPTION |
|---|---|
| P0-P1 | Initial pumping pressure rising interval |
| P1-P2 | Initial normal pumping interval |
| P2-P3 | High water level re-setting interval based on |
| | normal pumping pressure within water feed pipe |
| P3-P4 | Pumping stop interval based on high water level |
| P4-P5 | Water pressure varying interval based on altitude |
| | difference between intake chamber and storage tank |
| P5-P6 | Actual sensing interval for water level within water |
| | feed pipe, based on water consumption and re-intaking |

As seen from the graph of FIG. 35, the main controller 100 senses through the water pressure sensor 34 the following water pressures: initial water pressure P0 at the moment that it turns on the pumping unit 22 to intake initial raw water from the intake chamber 24; first water pressure P1 which is highest water pressure sensed after the initial pumping of the pumping unit 22; second water pressure P2 which is an initial average water pressure value where the pumping operation of the pumping unit 22 is normally stabilized after its initial pumping; third water pressure P3 where the current water level within the water storage tank 300 is re-set as a high water level; fourth water pressure P4 where the operation of the pumping unit 22 is stopped after the high water level is re-set; fifth water pressure P5 where the current water level within the storage tank 300 is re-set as a low water level after the operation of the pumping unit 22 is stopped; and sixth water pressure P6 where the pumping operation of the pumping unit 22 is restarted at the set low water level.

On the other hand, in the case where it is determined at the above third step S122 that abrupt variations exit between the first water pressure P1 and the second water pressure P2, as shown in the graph of FIG. 35, the main controller recognizes that the abrupt variations result from a choking of the water feed pipe 36 by alien substances, the OFF state of the ON/OFF valve 32 or a frozen and burst state of the pipe 36. Thus, the main controller 100 compares the abrupt variations with a previously automatically set value and, as a result of the comparison, stops the operation of the pumping unit 22 and generates an alarm.

That is, if sensed variations between the first water pressure P1 and the second water pressure P2 last above a predetermined pressure value (for example, 0.5 kg/cm²) for a predetermined period of time, the main controller 100 recognizes that the sensed variations result from the OFF state of the ON/OFF valve 32 or a frozen and burst state of the water feed pipe 36 and then stops the operation of the pumping unit 22.

The initial water pressure P0 based on the initial pumping operation is assigned a certain standby period of time t1 for which water pressure sensed by the water pressure sensor 34 is ignored. This standby time period assignment is conducted for preventing the pumping unit 22 from being stopped in operation because the water pressure sensed by the water pressure sensor 34 is higher than an average water pressure value or high water level pressure value stored in the main controller 100.

If the first condition is satisfied, then the main controller 100 re-sets an average water pressure value of the sensed water pressure variations as a new initial water pressure value at the fourth step S123. The re-set initial water pressure value is stored in the memory 18 such that it is compared with the subsequent initial water pressure value to be re-set. Thereafter, if the subsequent initial water pressure value is re-set, then it is stored in the memory 18.

After re-setting the initial water pressure value, at the fifth step S124, the main controller 100 senses variations in water pressure within the water feed pipe 36 through the water pressure sensor 34 and determines whether the sensed water pressure variations satisfy a second condition.

That is, the main controller 100 determines whether the sensed water pressure variations satisfy the second condition where an initially set reference value a1, for example, a value within the range of −0.01 to −0.1 kg/cm², preferably −0.03 kg/cm², last a predetermined number of times c1, for example, a value within the range of twice to 32 times, preferably 16 times, for a predetermined period of time t3, for example, a value within the range of 1 second to 5 minutes, preferably 30 seconds. This second condition is given for allowing the main controller 100 to sense the current water level within the water storage tank 300 while raw water is stored in the storage tank 300, determine whether the sensed current water level is the set high water level and re-set the sensed current water level as a substantial high water level value upon determining that it is the set high water level.

The main controller 100 determines whether the sensed water pressure variations satisfy the initially set reference value a1 the predetermined number of times c1 for the predetermined time period t3. Upon determining that the sensed water pressure variations do not satisfy the reference value a1, the main controller 100 continues to determine whether they satisfy the reference value a1 the same number of times c1 for the same time period t3. If the sensed water pressure variations are determined to satisfy the reference value a1, then the main controller 100 determines whether they satisfy an initially set reference value a2 a predetermined number of times c2, for example, a value within the range of twice to 32 times, preferably 16 times, for a predetermined period of time t4, for example, a value within the range of 1 second to 5 minutes, preferably 10 seconds. Upon determining that the sensed water pressure variations do not satisfy the reference value a2, the main controller 100 determines again whether they satisfy the reference value a1 the predetermined number of times c1 for the predetermined time period t3. Therefore, a high water level value can be set on the basis of more active determinations as to variations in water pressure.

The reference values a1 and a2 are initially set average water pressure values. In the second condition, the main controller 100 discards fluctuating pressure values, for example, ±0.03 kg/cm² for the predetermined time period t3 for which the determination is made as to whether the sensed water pressure variations satisfy the initially set reference value a1 the predetermined number of times c1, and for the predetermined time period t4 for which the determination is made as to whether the sensed water pressure variations satisfy the initially set reference value a2 the predetermined number of times c2. Namely, the main controller 100 discards undesirable variations in water pressures from the intake chamber 24 and water storage tank 300, transferred to the water feed pipe 36.

If the second condition is satisfied, at the sixth step (S125 and S126), the main controller 100 re-sets an average water pressure value of the sensed water pressure variations as a new high water level pressure value. The main controller 100 then senses variations in water pressure within the water feed pipe 36 through the water pressure sensor 34 and determines whether the sensed water pressure variations satisfy a third condition where they must be continuously maintained above a set stable value s3, for example, a value within the range of +0.01 to +0.1 kg/cm², preferably +0.03 kg/cm², for a predetermined period of time t5, for example, a value within the range of 1 second to 5 minutes, preferably 30 seconds. The main controller 100 also counts a predetermined number (for example, a value within the range of 2 to 32, preferably 16) for the above predetermined period of time t5.

If the third condition is satisfied, then the main controller 100 stops the operation of the pumping unit 22 at the seventh step S127.

After stopping the operation of the pumping unit 22, at the eighth step (S128 and S129), the main controller 100 senses variations in water pressure within the water feed pipe 36 through the water pressure sensor 34, determines whether the sensed water pressure variations satisfy a fourth condition and then sets an average water pressure value of the sensed water pressure variations as a new low water level pressure value in accordance with the determined result.

That is, the main controller 100 senses variations in water pressure within the water feed pipe 36 through the water pressure sensor 34 and determines whether the sensed water pressure variations satisfy the fourth condition where they must be continuously maintained within the range of an initially set stable value s3, for example, within the range of ±0.01 to ±0.1 kg/cm², preferably within the range of ±0.02 kg/cm², for a predetermined period of time t6, for example, a value within the range of 1 second to 5 minutes, preferably 30 seconds. Upon determining that the sensed water pressure variations satisfy the fourth condition, the main controller 100 sets an average water pressure value of the sensed water pressure variations as a new low water level pressure value. In this manner, the main controller 100 automatically re-sets a new water pressure value lower by a certain value than the above re-set high water level pressure value, as a low water level pressure value. Namely, the main controller 100 automatically re-sets a pressure value corresponding to a water level lower by a certain depth (for example, 1 m) than the re-set high water level, as a new low water level pressure value, or a water pressure value lower by a certain pressure value (10 kg/cm²) than the re-set high water level pressure value, as a new low water level pressure value. In other words, the main controller 100 re-sets a low water level point at which raw water is not completely discharged from the water storage tank 300, by subtracting a certain value from a previously re-set high water level point.

After re-setting the low water level pressure value, at the ninth step (S130 and S131), the main controller 100 senses water pressure within the water feed pipe 36 through the water pressure sensor 34 in the pipe 36 for a certain period of time that raw water stored in the water storage tank 300 is consumed and then determines whether the sensed water pressure value is the re-set low water level pressure value. Namely, after re-setting the low water level pressure value at the above step S129, the main controller 100 determines whether the water level within the storage tank 300 has reached the re-set low water level due to the water consumption. At this time, even though determining that the water level within the storage tank 300 has reached the re-set low water level, the main controller 100 normally turns on the pumping unit 22 only when the water level within the storage tank 300 is maintained lower than or equal to the re-set low water level for a predetermined period of time t7. This is particularly applicable to the case where the water storage tank 300 is located in the rooftop of a building or a region relatively higher than the ground. A timer may also be provided according to a set function.

If it is determined at the above step S131 that the water level within the storage tank 300 has reached the re-set low water level, at the tenth step (S132 and S133), the main controller 100 senses variations in water pressure within the water feed pipe 36 through the water pressure sensor 34 and then determines whether the sensed water pressure variations satisfy a fifth condition where they must be continuously maintained below a set stable value s4, for example, a value within the range of −0.01 to −0.1 kg/cm², preferably −0.03 kg/cm², for a predetermined period of time t7, for example, a value within the range of 1 second to 5 minutes, preferably 30 seconds. Upon determining that the sensed water pressure variations satisfy the fifth condition, the main controller 100 resumes the operation of the pumping unit 22 to re-intake raw water from the intake chamber 24.

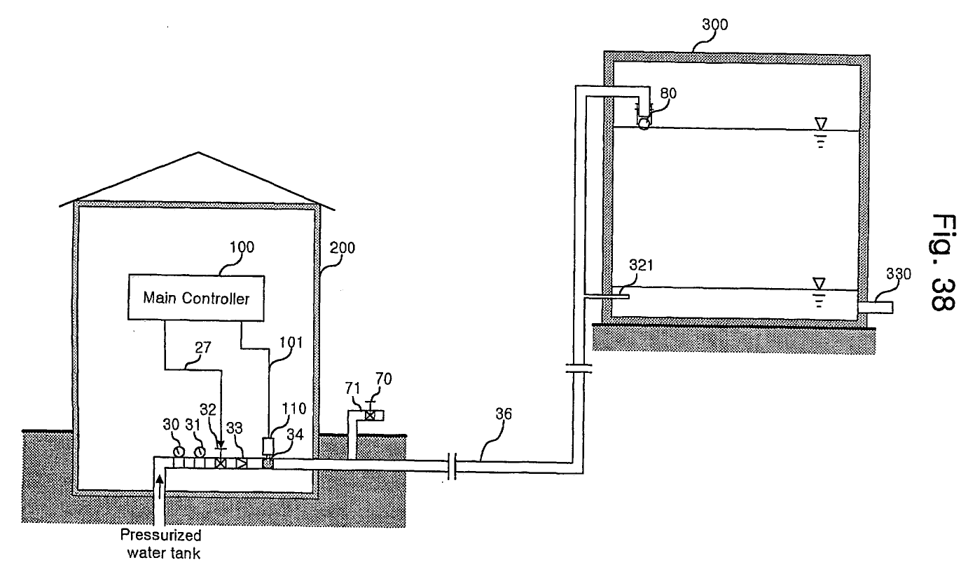

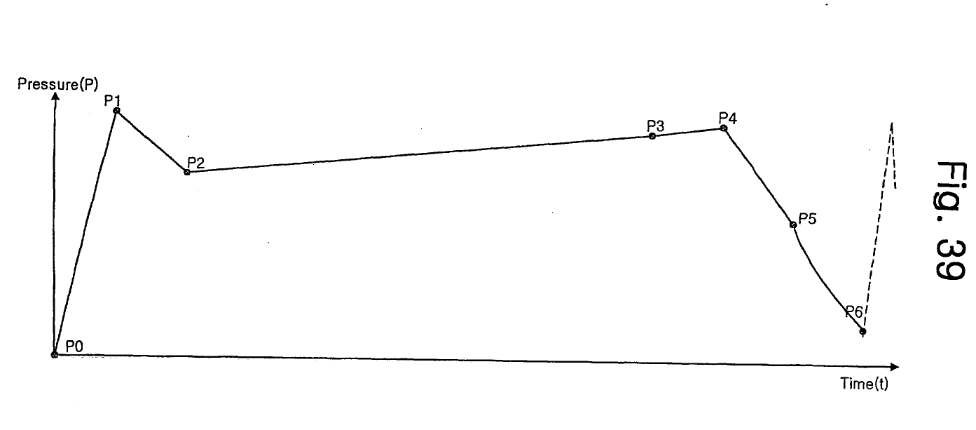

FIG. 38 is a view showing a seventh embodiment of the automatic wireless water level control system in accordance with the present invention, which is applied to a pressurized water tank, and FIG. 39 is a graph showing water pressure variations in the automatic wireless water level control system applied to the pressurized water tank in accordance with the present invention.

The pressurized water tank is driven in a similar manner to the intake chamber, but raw water therefrom is fed at almost constant pressure differently from the intake chamber. As a result, in the pressurized water tank, a high water level is set on the basis of water pressure rising after an initial value is set with the driving of the pumping unit. In the pressurized water tank, the high water level will be set on the basis of water pressure variations satisfying the second condition.

A method for controlling the level of raw water from the pressurized water tank is performed in a similar manner to the above-stated method for controlling the level of raw water from the intake chamber. That is, the method for controlling the level of raw water from the pressurized water tank comprises the first step of installing the automatic wireless water level control system and setting a variety of initial values about water pressure within the water storage tank, the second step of driving the intake pumping unit to intake raw water from the pressurized water tank, the third step of sensing variations in water pressure within the water feed pipe through the water pressure sensor while raw water pumped out by the pumping unit is fed to the water storage tank through the pipe, and then determining whether the sensed water pressure variations satisfy a first condition, the fourth step of re-setting an average water pressure value of the water pressure variations sensed at the above third step as an initial water pressure value if the water pressure variations sensed at the above third step satisfy the first condition, the fifth step of sensing variations in water pressure within the water feed pipe through the water pressure sensor after the initial water pressure value is re-set and then determining whether the sensed water pressure variations satisfy a second condition, the sixth step of re-setting an average water pressure value of the water pressure variations sensed at the above fifth step as a high water level pressure value if the water pressure variations sensed at the above fifth step satisfy the second condition, sensing variations in water pressure within the water feed pipe through the water pressure sensor and determining whether the sensed water pressure variations satisfy a third condition, the seventh step of stopping the operation of the pumping unit if the water pressure variations sensed at the above sixth step satisfy the third condition, the eighth step of sensing variations in water pressure within the water feed pipe through the water pressure sensor after the operation of the pumping unit is stopped, determining whether the sensed water pressure variations satisfy a fourth condition and then re-setting an average water pressure value of the sensed water pressure variations as a low water level pressure value if the sensed water pressure variations satisfy the fourth condition, the ninth step of sensing water pressure within the water feed pipe through the water pressure sensor for a certain period of time that raw water stored in the water storage tank is consumed after the low water level pressure value is re-set and then determining whether the sensed water pressure value is the re-set low water level pressure value, and the tenth step of sensing variations in water pressure within the water feed pipe through the water pressure sensor if the water pressure value sensed at the above ninth step is the re-set low water level pressure value, determining whether the sensed water pressure variations satisfy a fifth condition and then resuming the operation of the pumping unit to re-intake raw water from the pressurized water tank, if the sensed water pressure variations satisfy the fifth condition.

This pressurized water tank water level control method is preferably applied to the case where the water storage tank is located in a region relatively higher than the pressurized water tank. After the first condition is satisfied and the initial pressure value is thus re-set, pressure rises by a height from the pressurized water tank to the water storage tank to push raw water from the water tank upward to the storage tank due to an altitude difference between the tanks.

The third condition is given at the above sixth step for the purpose of stopping the operation of the pumping unit when the current water pressure satisfies defined criteria for a predetermined period of time. The above-stated pressurized water tank water level control method is similarly applicable to a construction where a plurality of water storage tanks are connected to one pressurized water tank.

As described above, the automatic wireless water level control method, which is performed by the automatic wireless water level control system according to the present invention, is applicable to a construction where one intake chamber and one pumping unit are connected to a plurality of water storage tanks, and to the case where a water storage tank is located in the rooftop of a building or a region relatively higher than an intake chamber. The present automatic wireless water level control system compares sensed water pressure variations with a previously automatically set high water level pressure value continuously for a predetermined period of time. If the sensed water pressure variations are maintained higher than or equal to the set high water level pressure value for the predetermined time period, the system turns off the operation of the pumping unit and generates an alarm. This system is also applicable to the case where the ON/OFF valve is turned off, the water feed pipe is choked or raw water is used via the bypass pipe. The memory 18 may preferably have an appropriately small capacity in that it stores set high and low water level pressure values in a push-pull manner.

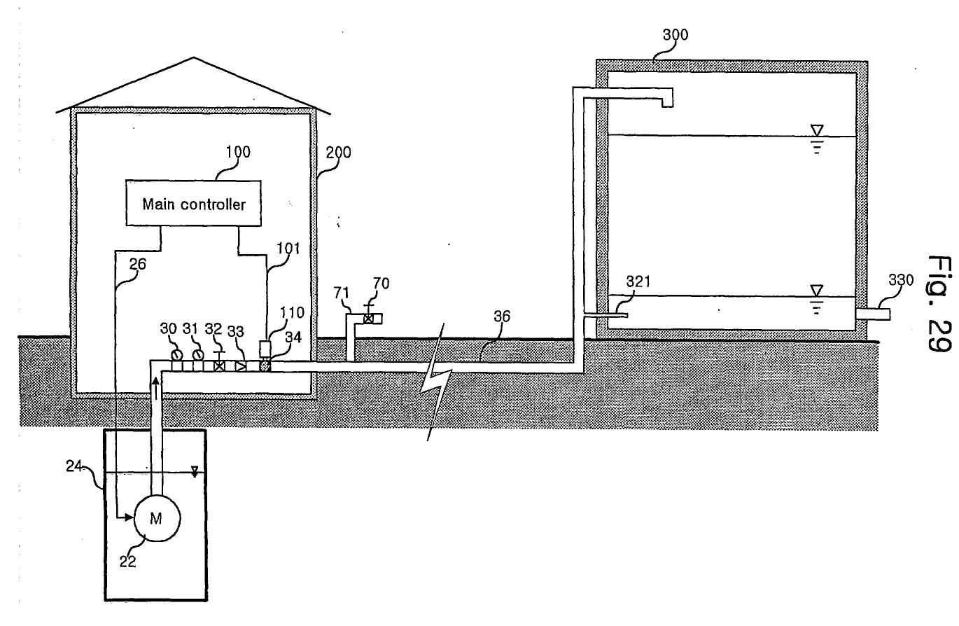

FIGS. 30 to 32 are views showing yet other embodiments of the structure for sensing water pressure within the water storage tank 300 in accordance with the present invention. In FIG. 30, the end 36a of the water feed pipe 36 extends such that it is immersed in raw water which is stored in the storage tank 300 up to a high level. This structure of FIG. 30 is provided to readily sense and recognize water pressure variations without using a separate float. The water pressure sensing pipe 321 extends from the water feed pipe 36 to sense pressure of the raw water stored in the storage tank 300.

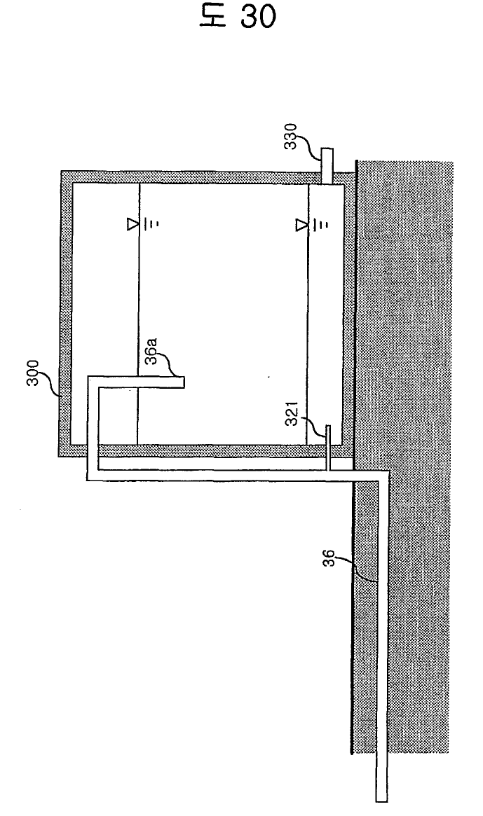

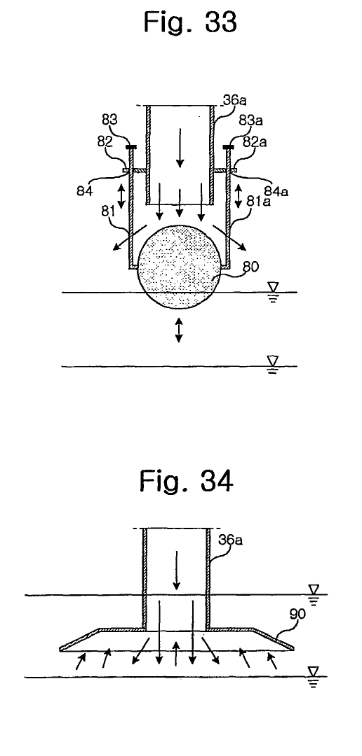

In FIG. 31, a reflector 90 is connected to the end 36a of the water feed pipe 36 extending as shown in FIG. 30, to prevent water pressure within the water storage tank 300 from varying abruptly due to pressure of raw water fed through the pipe 36 while the water level within the storage tank 300 rises. Namely, as shown in detail in FIG. 34, the reflector 90 is connected to the end 36a of the water feed pipe 36 to prevent the level of raw water within the storage tank 300 from being fluctuated by raw water fed through the pipe 36. When raw water is filled within the water storage tank 300 above the reflector 90, there is little variation in water pressure resulting from water level fluctuations.

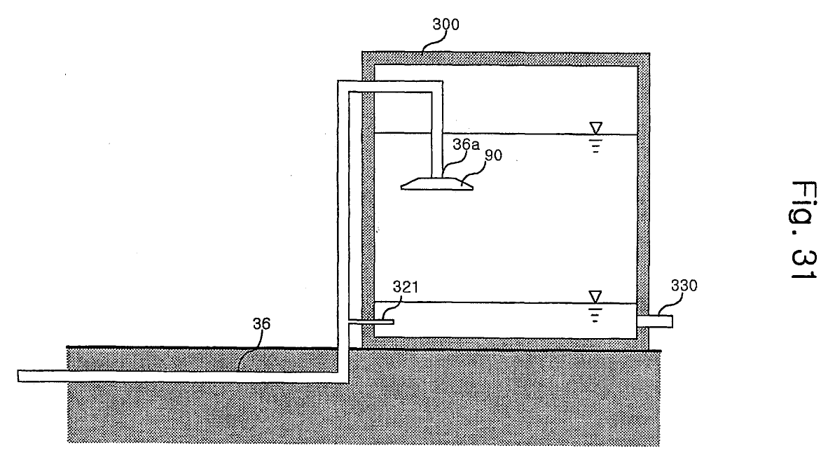

In FIG. 32, the end 36a of the water feed pipe 36 terminates at a lower portion inside the water storage tank 300 to feed raw water from the intake chamber to the lower portion inside the storage tank 300. This structure of FIG. 32 enables one water feed pipe 36 to carry out both the water feeding and water pressure sensing.

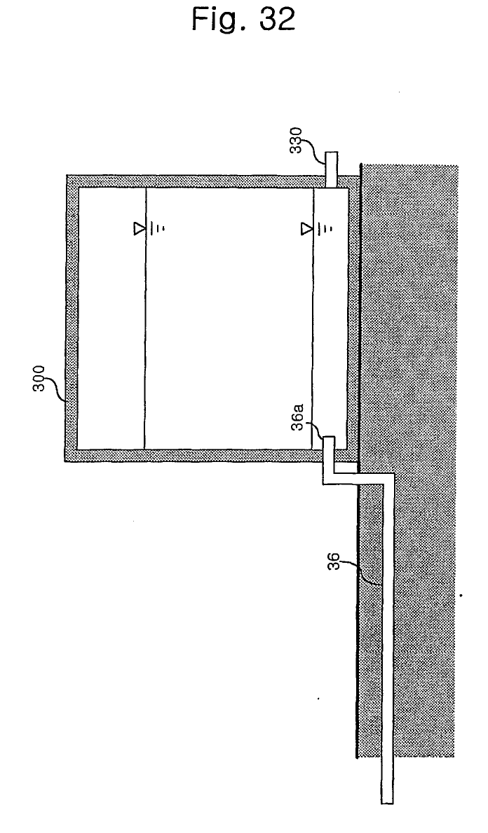

FIG. 33 is a sectional view showing a structure of a float 80 which is connected to the end 36a of the water feed pipe 36 extending to the water storage tank 300, to minimize water pressure variations in setting a high water level pressure value. It is preferable to set a high water level pressure value without employing the float 80.

The float 80 is supported by a plurality of support members 81 and 81a such that it ascends and descends along guide holes 84 and 84a of guide lines 82 and 82a of the pipe end 36a. Under the condition that the float 80 is not brought into contact with raw water within the water storage tank 300, it is hung from the guide lines 82 and 82a via stoppers 83 and 83a due to its own weight. With the increase in water level within the water storage tank 300, the float 80 ascends to transfer the increase in water pressure within the storage tank 300 through the water feed pipe 36. The float 80 functions to minutely turn on/off the discharge of raw water from the end 36a of the water feed pipe 36 to the water storage tank 300. In this regard, the float 80 preferably has a minimized size for such a function. It is more preferable to readily set high and low water level pressure values based on the storage of raw water within the storage tank 300 without installing the float 80. This float 80 may have a cuboidal or polyhedral shape as well as a spherical shape.

As stated above, the automatic wireless water level control method of the present invention is applicable to either an intake chamber or pressurized water tank to remotely control more accurately high and low levels of raw water within a water storage tank on the basis of water pressure within a water feed pipe so as to readily control the water level within the storage tank without separate wiring.

Industrial Applicability

As apparent from the above description, the present invention provides automatic wireless water level control system and method applicable to either an intake chamber or pressurized water tank. Instead of installing an electrode rod within the intake chamber, a water pressure sensor is mounted on a water feed pipe to sense pressure of raw water pumped out from the intake chamber by an intake pumping unit. A water amount or level within the intake chamber is judged from the water pressure sensed by the water pressure sensor, and the pumping unit is controlled in operation in accordance with the judged result. The feeding of raw water from the pressurized water tank is also controlled in accordance with the judged result. As a result, when the water amount or level within the intake chamber is below a reference value, the pumping unit can be prevented from being deteriorated and damaged due to its continuous operation. Further, the automatic wireless water level control system senses a water amount or level within a water storage tank through the water pressure sensor and controls the pumping unit if the sensed water level is high or low, thereby controlling the water level within the storage tank in a wireless manner. The system comprises a main controller including a control unit and control panel capable of setting the operation mode of the pumping unit to an automatic mode, a manual mode or an intake mode based on the output of the water pressure sensor, and setting an intake period of time in response to a user's operation, thereby enabling a more automated intaking process. Therefore, the present invention has the effect of lengthening the lifetime of the pumping unit, significantly reducing installation and maintenance costs owing to the control for the pumping unit in a wireless manner, more effectively intaking raw water, actively controlling the level of raw water and significantly increasing antiweatherability and durability of the water feed pipe and being applicable to a domestic field, industrial field, agricultural field, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for automatically controlling a water level wirelessly, comprising the steps of:
a) installing an automatic wireless water level control system and setting a variety of initial values about water pressure within a water storage tank;
b) driving intake pumping means to intake raw water from an intake chamber;
c) sensing variations in water pressure within a water feed pipe through water pressure sensing means while raw water pumped out by said pumping means is fed to said water storage tank through said water feed pipe, and then determining whether the sensed water pressure variations satisfy a first condition;
d) re-setting an average water pressure value of said water pressure variations sensed at said step c) as an initial water pressure value if said water pressure variations sensed at said step c) satisfy said first condition;
e) sensing variations in water pressure within said water feed pipe through said water pressure sensing means after the initial water pressure value is re-set and then determining whether the sensed water pressure variations satisfy a second condition;
f) re-setting an average water pressure value of said water pressure variations sensed at said step e) as a high water level pressure value if said water pressure variations sensed at said step e) satisfy said second condition, sensing variations in water pressure within said water feed pipe through said water pressure sensing means and determining whether the sensed water pressure variations satisfy a third condition;
g) stopping the operation of said pumping means if said water pressure variations sensed at said step f) satisfy said third condition;
h) sensing variations in water pressure within said water feed pipe through said water pressure sensing means after the operation of said pumping means is stopped, determining whether the sensed water pressure variations satisfy a fourth condition and then re-setting an average water pressure value of the sensed water pressure variations as a low water level pressure value if the sensed water pressure variations satisfy said fourth condition;
i) sensing water pressure within said water feed pipe through said water pressure sensing means for a certain period of time that raw water stored in said water storage tank is consumed after the low water level pressure value is re-set and then determining whether the sensed water pressure value is the re-set low water level pressure value; and
j) sensing variations in water pressure within said water feed pipe through said water pressure sensing means if said water pressure value sensed at said step i) is said re-set low water level pressure value, determining whether the sensed water pressure variations satisfy a fifth condition and then resuming the operation of said pumping means to re-intake raw water from said intake chamber, if the sensed water pressure variations satisfy said fifth condition.

2. The method as set forth in claim 1, wherein said water pressure sensing means is adapted to sense:
initial water pressure at the moment that said intake pumping means is turned on;
first water pressure which is highest water pressure sensed after the initial pumping of said pumping means;
second water pressure which is an initial average water pressure value where the pumping operation of said pumping means is normally stabilized after its initial pumping;
third water pressure where the current water level within said water storage tank is re-set as a high water level;
fourth water pressure where the operation of said pumping means is stopped after the high water level is re-set;
fifth water pressure where the current water level within said water storage tank is re-set as a low water level after the operation of said pumping means is stopped; and
sixth water pressure where the pumping operation of said pumping means is restarted at the set low water level.

3. The method as set forth in claim 2, wherein said initial water pressure based on said initial pumping operation is assigned a certain standby period of time (t1) for which water pressure sensed by said water pressure sensing means is ignored.

4. The method as set forth in claim 1, wherein said first condition signifies that said water pressure variations sensed at said step c) must be continuously maintained within the range of an initial set stable value (s1: ±0.01 to ±0.5 kg/cm²) for a predetermined period of time (t2: 1 second to 5 minutes).

5. The method as set forth in claim 4, wherein said step d) includes the step of, if said water pressure variations sensed at said step c) are continuously maintained above a predetermined pressure value (s2: +0.5 kg/cm²) for said predetermined period of time (t2), recognizing that an ON/OFF valve has been turned off or said water feed pipe has been frozen and burst and then turning off said pumping means and generating an alarm.

6. The method as set forth in claim 4, wherein said step d) includes the step of, if said water pressure variations sensed at said step c) fall constantly below a predetermined pressure value (s2: −0.01 kg/cm²) for said predetermined time period (t2), recognizing that raw water from said water feed pipe is in use by a bypass pipe.

7. The method as set forth in claim 1, wherein said second condition signifies that said water pressure variations sensed at said step e) must satisfy an initially set reference value (a1: −0.01 to −0.1 kg/cm²) a predetermined number of times (c1: 2 to 32 times) for a predetermined period of time (t3: 1 second to 5 minutes), and wherein said step f) includes the step of, if said water pressure variations sensed at said step e) do not satisfy said reference value (a1), continuing to determine whether they satisfy said reference value (a1) the same number of times (c1) for the same time period (t3), and if said water pressure variations sensed at said step e) satisfy said reference value (a1), determining whether they satisfy an initially set reference value (a2: +0.01 to +0.1 kg/cm²) a predetermined number of times (c2: 2 to 32 times) for a predetermined period of time (t4: 1 second to 5 minutes) and if said water pressure variations sensed at said step e) do not satisfy said reference value (a2), again determining whether they satisfy said reference value (a1) said predetermined number of times (c1) for said predetermined time period (t3).

8. The method as set forth in claim 7, wherein said reference values (a1) and (a2) are initially set average water pressure values.

9. The method as set forth in claim 7, wherein said step f) further includes the step of discarding fluctuating pressure values for said predetermined time period (t3: 1 second to 5 minutes) for which the determination is made as to whether said water pressure variations sensed at said step e) satisfy said initially set reference value (a1: −0.01 to −0.1 kg/cm²) said predetermined number of times (c1: 2 to 32 times), and for said predetermined time period (t4: 1 second to 5 minutes) for which the determination is made as to whether said water pressure variations sensed at said step e) satisfy said initially set reference value (a2: +0.01 to +0.1 kg/cm²) said predetermined number of times (c2: 2 to 32 times).

10. The method as set forth in claim 1, wherein said third condition signifies that said water pressure variations sensed at said step f) must be continuously maintained above an initially set stable value (s3: +0.01 to +0.1 kg/cm²) for a predetermined period of time (t5: 1 second to 5 minutes).

11. The method as set forth in claim 1, wherein said fourth condition signifies that said water pressure variations sensed at said step h) must be continuously maintained within the range of an initially set stable value (s3: ±0.01 to ±0.1 kg/cm²) for a predetermined period of time (t6: 1 second to 5 minutes), and wherein said step h) includes the step of re-setting the average water pressure value of said water pressure variations sensed at said step h) as said low water level pressure value if said water pressure variations sensed at said step h) are continuously maintained within the range of said initially set stable value (s3) for said predetermined time period (t6).

12. The method as set forth in claim 1, wherein said fifth condition signifies that said water pressure variations sensed at said step j) must be continuously maintained below an initially set stable value (s4: −0.01 to −0.1 kg/cm²) for a predetermined period of time (t7: 1 second to 5 minutes).

13. The method as set forth in claim 1, wherein a float of a minimized size is connected or not connected to an end of said water feed pipe to minimize water pressure variations in re-setting said high water level pressure value at said step f).

14. The method as set forth in claim 1, wherein said water feed pipe has its end extending up to a water level between high and low water levels within said water storage tank for minimizing water pressure variations in re-setting said high water level pressure value at said step f).

15. The method as set forth in claim 14, wherein a reflector is connected to said extending end of said water feed pipe to minimize water pressure variations.

16. The method as set forth in claim 1, wherein said step j) includes the step of resuming the operation of said pumping means if said water pressure variations sensed at said step j) are maintained within the range of −0.01 to −0.1 kg/cm² from said re-set low water level pressure value.

17. The method as set forth in claim 1, wherein said intake chamber and pumping means are connected to a plurality of water storage tanks.

18. The method as set forth in claim 1, wherein said intake chamber is installed in any one of a underground water source, a tube well or a well automation system.

19. A method for automatically controlling a water level wirelessly, comprising the steps of:
a) installing a system for automatically controlling a water level within a water storage tank wirelessly, and then setting a variety of initial values about water pressure within said water storage tank;
b) driving intake pumping means to intake raw water from a pressurized water tank;
c) sensing variations in water pressure within a water feed pipe through water pressure sensing means while raw water pumped out by said pumping means is fed to said water storage tank through said water feed pipe, and then determining whether the sensed water pressure variations satisfy a first condition;
d) re-setting an average water pressure value of said water pressure variations sensed at said step c) as an initial water pressure value if said water pressure variations sensed at said step c) satisfy said first condition;
e) sensing variations in water pressure within said water feed pipe through said water pressure sensing means after the initial water pressure value is re-set and then determining whether the sensed water pressure variations satisfy a second condition;
f) re-setting an average water pressure value of said water pressure variations sensed at said step e) as a high water level pressure value if said water pressure variations sensed at said step e) satisfy said second condition, sensing variations in water pressure within said water feed pipe through said water pressure sensing means and determining whether the sensed water pressure variations satisfy a third condition;
g) stopping the operation of said pumping means if said water pressure variations sensed at said step f) satisfy said third condition;
h) sensing variations in water pressure within said water feed pipe through said water pressure sensing means after the operation of said pumping means is stopped, determining whether the sensed water pressure variations satisfy a fourth condition and then re-setting an average water pressure value of the sensed water pressure variations as a low water level pressure value if the sensed water pressure variations satisfy said fourth condition;
i) sensing water pressure within said water feed pipe through said water pressure sensing means for a certain period of time that raw water stored in said water storage tank is consumed after the low water level pressure value is re-set and then determining whether the sensed water pressure value is the re-set low water level pressure value; and
j) sensing variations in water pressure within said water feed pipe through said water pressure sensing means if said water pressure value sensed at said step i) is said re-set low water level pressure value, determining whether the sensed water pressure variations satisfy a fifth condition and then resuming the operation of said pumping means to re-intake raw water from said pressurized water tank, if the sensed water pressure variations satisfy said fifth condition.

20. The method as set forth in claim 19, wherein said water storage tank is located in a region relatively higher than said pressurized water tank.

21. The method as set forth in claim 19, wherein pressure rises by a height from said pressurized water tank to said water storage tank after said first condition is satisfied and said initial water pressure value is thus re-set at said step d).

22. The method as set forth in claim 19, wherein said third condition signifies that said water pressure variations sensed at said step f) must satisfy a predetermined value for a predetermined period of time, and wherein said step g) includes the step of stopping the operation of said pumping means if said water pressure variations sensed at said step f) satisfy said predetermined value for said predetermined period of time.

23. The method as set forth in claim 19, wherein said pressurized water tank is connected to a plurality of water storage tanks.

24. A method for automatically controlling a water level wirelessly, comprising the steps of:
a) installing an automatic wireless water level control system;
b) driving intake pumping means to feed raw water from an intake chamber to a water storage tank and store it in said storage tank;
c) setting high and low levels of the raw water stored in said water storage tank as initial values;
d) sensing water pressure within said water storage tank through water pressure sensing means;
e) determining from said water pressure sensed at said step d) whether the current water level within said water storage tank is said set low level;
f) if it is determined at said step e) that the current water level within said water storage tank is said set low level, supplying power to said pumping means to drive it so as to pump out raw water from said intake chamber;
g) sensing pressure of the raw water pumped out from said intake chamber through said water pressure sensing means;
h) determining whether the pressure value sensed at said step g) is a predetermined reference value;
i) if it is determined at said step h) that said pressure value sensed at said step g) is lower than or equal to said predetermined reference value, interrupting the supply of power to said pumping means to stop the operation thereof;
j) determining whether a predetermined period of time has elapsed after the operation of said pumping means is stopped;
k) resuming the pumping operation if it is determined at said step j) that said predetermined period of time has elapsed;
l) sensing water pressure within a water feed pipe in connection with water pressure within said water storage tank through said water pressure sensing means;
m) determining from said water pressure sensed at said step l) whether the current water level within said water storage tank is said set high level;
n) stopping the operation of said pumping means if it is determined at said step m) that the current water level within said water storage tank is said set high level; and
o) re-setting the current water level within said water storage tank as a new high water level value and then continuing to sense variations in water pressure within said storage tank.

25. A system for automatically controlling a water level wirelessly, comprising:
an intake chamber for intaking raw water;
intake pumping means for pumping out the raw water from said intake chamber;
a water feed pipe for feeding the raw water pumped out by said pumping means;
water pressure sensing means for sensing water pressure within said water feed pipe;
a check valve for preventing a backflow of the raw water pumped out by said intake pumping means;
a water storage tank for storing the raw water fed through said water feed pipe;
a drive controller for processing electrical data from said water pressure sensing means; and
a main controller for monitoring, controlling and displaying a variety of states of the system.

26. The system as set forth in claim 25, wherein said main controller includes:
a power supply for supplying drive power to the system;
a control panel for setting and controlling an operation mode of said intake pumping means and displaying an operated state of said pumping means;
a memory for outputting set data or storing input data;
a control unit for analyzing an output signal from said control panel and outputting a control signal back to said control panel or a drive control signal to said intake pumping means in accordance with the analyzed result;
a communication unit for transmitting and receiving water pressure and control signals; and
an electronic switch for supplying or interrupting the power from said power supply to said intake pumping means via a power supply line under the control of said control unit.

27. The system as set forth in claim 26, wherein said control panel includes:
a display window including state display means for displaying the current state of said main controller, water pressure display means for displaying the water pressure within said water feed pipe, and water level display means for displaying the level of raw water within said water storage tank;
function key input means including a mode setting key for setting the operation mode of said intake pumping means to an automatic mode or manual mode, a motor setting key for driving said pumping means when the operation mode of said pumping means is set to said manual mode, a level setting key for setting a water level depending on water pressure sensed by said water pressure sensing means, a restart time setting key for setting an operation restart time of said intake pumping means when the current water pressure becomes abnormal as said pumping means is driven, a start time setting key for setting a stabilization period of time based on water pressure sensed by said water pressure sensing means when said pumping means is driven because the current water level is low, an end time setting key for setting a period of time that said pumping means is driven before it is turned off after the current water level is determined to be full from water pressure sensed by said water pressure sensing means, a password setting key for maintaining the security of said main controller, and a cancel key for canceling a corrected value after said main controller is set; and
selection key input means including a storage setting key for storing values set by the user, an up setting key for increasing a number displayed on said state display means after said main controller is set, a down setting key for reducing a number displayed on said state display means after said main controller is set, a first figure setting key for shifting to the left figures of a number displayed on said state display means after said main controller is set, and a second figure setting key for shifting to the right figures of a number displayed on said state display means after said main controller is set.

28. The system as set forth in claim 25, wherein said drive controller includes:
an input unit for inputting an analog water pressure signal from said water pressure sensing means in the form of a voltage or current;
an interface for converting the analog water pressure signal inputted by said input unit into a digital signal and transferring the converted digital signal to said main controller; and
a display unit for providing a visual indication of an operated state of said drive controller.

29. The system as set forth in claim 26, wherein, in the case where an unrestricted amount of raw water is intaken from said intake chamber,
said water pressure sensing means is adapted to sense the water pressure within said water feed pipe in connection with water pressure within said water storage tank, convert the sensed water pressure into an electrical signal and output the converted electrical signal to said control unit; and
said control unit is operated in response to an output signal from said water pressure sensing means to, if said water pressure sensed by said water pressure sensing means increases and then exceeds a first predetermined value for a predetermined period of time, output a first control signal to said electronic switch to interrupt power to said pumping means, and, if said water pressure sensed by said water pressure sensing means falls below a second predetermined value, output a second control signal to said electronic switch to supply power to said pumping means.

30. The system as set forth in claim 26, wherein, in the case where a limited amount of raw water is intaken from said intake chamber,
said water pressure sensing means is adapted to sense the water pressure within said water feed pipe in connection with water pressure within said water storage tank, convert the sensed water pressure into an electrical signal and output the converted electrical signal to said control unit; and
said control unit is operated in response to an output signal from said water pressure sensing means to, if said water pressure sensed by said water pressure sensing means varies instantaneously and abruptly a predetermined number of times or more for a first predetermined period of time, output a first control signal to said electronic switch to interrupt power to said pumping means, if a second predetermined period of time elapses from a time point of the power interruption to said pumping means, output a second control signal to said electronic switch to supply power to said pumping means so as to resume the pumping operation, and, if said water pressure sensed by said water pressure sensing means increases and then exceeds a predetermined value for a third predetermined period of time, output said first control signal to said electronic switch to interrupt power to said pumping means.

31. The system as set forth in claim 26, wherein said water pressure sensing means includes first and second water pressure sensors mounted on said water feed pipe, said first water pressure sensor sensing pressure of the raw water intaken from said intake chamber and outputting the resulting sense signal to said control unit, said second water pressure sensor sensing the water pressure within said water feed pipe in connection with water pressure within said water storage tank and outputting the resulting sense signal to said control unit.

32. The system as set forth in claim 26 or claim 31, wherein, in the case where an unrestricted amount of raw water is intaken from said intake chamber,
said first water pressure sensor is adapted to sense predetermined pressure of the raw water pumped out by said pumping means;
said second water pressure sensor is adapted to sense the water pressure within said water feed pipe in connection with the water pressure within said water storage tank; and
said control unit is operated in response to an output signal from said first water pressure sensor to, if said water pressure sensed by said first water pressure sensor is maintained below a first predetermined value or above a second predetermined value for a first predetermined period of time, output a first control signal to said electronic switch to interrupt power to said pumping means, and operated in response to an output signal from said second water pressure sensor to, if said water pressure sensed by said second water pressure sensor is maintained above a third predetermined value for a second predetermined period of time, output said first control signal to said electronic switch to interrupt power to said pumping means, and, if said water pressure sensed by said second pressure sensor is below a fourth predetermined value, output a second control signal to said electronic switch to supply power to said pumping means.

33. The system as set forth in claim 26 or claim 31, wherein, in the case where a limited amount of raw water is intaken from said intake chamber,
said first water pressure sensor is adapted to sense pressure of the raw water pumped out by said pumping means;
said second water pressure sensor is adapted to sense water pressure within said water feed pipe rising from an initial value to a first predetermined value while said pumping means is driven, and the water pressure within said water feed pipe in connection with the water pressure within said water storage tank while the operation of said pumping means is stopped; and
said control unit is operated in response to an output signal from said first water pressure sensor to, if said water pressure sensed by said first water pressure sensor varies instantaneously and abruptly a predetermined number of times or more for a first predetermined period of time, output a first control signal to said electronic switch to interrupt power to said pumping means so as to stop the pumping operation, if a second predetermined period of time elapses from a time point of the power interruption to said pumping means, output a second control signal to said electronic switch to supply power to said pumping means so as to resume the pumping operation, and, if said water pressure sensed by said first water pressure sensor rises or falls abnormally for a third predetermined period of time, output said first control signal to said electronic switch to interrupt power to said pumping means, and operated in response to an output signal from said second water pressure sensor to, if said water pressure sensed by said second water pressure sensor is maintained above a second predetermined value for a fourth predetermined period of time, output said first control signal to said electronic switch to interrupt power to said pumping means so as to stop the operation thereof.

34. The system as set forth in claim 26 or claim 31, wherein each of said first and second water pressure sensors is provided within an internal pipe of said water feed pipe or formed integrally with said water feed pipe therein.

35. The system as set forth in claim 26 or claim 31, wherein a plurality of pumping means and a plurality of water feed pipes are connected to said water storage tank, each of said first and second water pressure sensors being mounted on each of said water feed pipes to sense water pressure within a corresponding one of said water feed pipes and output the sensed pressure value to said control unit, said control unit being operated in response to an output signal from each of said first and second water pressure sensors to display each water amount or level value on a display window of said control panel and store it in said memory.

36. The system as set forth in claim 26 or claim 31, wherein one pumping means and a plurality of water feed pipes are connected to a plurality of water storage tanks, each of said first and second water pressure sensors being mounted on each of said water feed pipes to sense water pressure within a corresponding one of said water feed pipes and output the sensed pressure value to said control unit, said control unit being operated in response to an output signal from each of said first and second water pressure sensors to display each water amount or level value on a display window of said control panel and store it in said memory.

37. The system as set forth in claim 26 or claim 31, wherein said second water pressure sensor includes a pneumatic sensor mounted on a pneumatic pipe within said intake chamber for sensing a water level within said intake chamber.

38. The system as set forth in claim 25, wherein, in the case where an unrestricted amount of raw water is intaken from said intake chamber, said main controller is adapted to increase the amount of current and the level of a voltage applied to said pumping means if the level of raw water within said water storage tank is above a predetermined value, decrease them if the water level within said water storage tank is below said predetermined value and control the operation of said pumping means on the basis of the increases and decreases in the current amount and voltage level.

39. The system as set forth in claim 25, further comprising:
a T-shaped pipe coupling provided at a lower portion inside said water storage tank, said T-shaped pipe coupling having an inlet port connected to an end of said water feed pipe and an outlet port connected to on/off means via a discharge pipe; and
a water pressure sensing pipe extending from an intermediate point between said inlet and outlet ports of said T-shaped pipe coupling for sensing pressure of the raw water stored in said storage tank.

40. The system as set forth in claim 39, wherein said water pressure sensing pipe extends from said intermediate point between said inlet and outlet ports of said T-shaped pipe coupling to a certain length, and wherein said system further comprises a flared tube formed at an end of said water pressure sensing pipe for accurately sensing the water pressure within said water storage tank, said flared tube being positioned in said storage tank in the opposite direction to a water feed pipe of said storage tank or in such a manner that it is little influenced by said water feed pipe of said storage tank.

41. The system as set forth in claim 40, further comprising an auxiliary pipe extending from said flared tube, said auxiliary pipe having a plurality of water pressure holes for minimizing a fluctuation of the raw water within said water storage tank.

42. The system as set forth in claim 39, wherein said on/off means includes a spherical or conical float.

43. The system as set forth in claim 25, further comprising an internal pipe inserted into said water feed pipe for sensing only water pressure within said water storage tank.
